(19) United States
(12) Patent Application Publication
(10) Pub. No.: US 2025/0278800 A1
(43) Pub. Date: Sep. 4, 2025

(54) Method and Apparatus for Controlling Access to Power Internet of Things, Storage Medium and Processor

(71) Applicant: Zhongshan Power Supply Bureau of Guangdong Power Grid Co Ltd., Zhongshan City (CN)

(72) Inventors: Xiangfeng ZHOU, Zhongshan City (CN); Chunyuan CAI, Zhongshan City (CN); Yongjian LI, Zhongshan City (CN); Lifei LI, Zhongshan City (CN); Weixia JIAN, Zhongshan City (CN); Zhenjiang CHEN, Zhongshan City (CN); Hua LI, Zhongshan City (CN); Huibin ZHOU, Zhongshan City (CN); Ying ZHANG, Zhongshan City (CN)

(73) Assignee: Zhongshan Power Supply Bureau of Guangdong Power Grid Co Ltd., Zhongshan City (CN)

(21) Appl. No.: 18/790,234

(22) Filed: Jul. 31, 2024

(30) Foreign Application Priority Data
Mar. 1, 2024 (CN) 202410239662.8

(51) Int. Cl. G06Q 50/06; G06F 17/18; G06Q 40/04

(52) U.S. Cl. CPC G06Q 50/06; G06F 17/18; G06Q 40/04

(57) ABSTRACT

Provided are a method and apparatus for controlling access to power Internet of Things, a storage medium and a processor. In the method, the information benefit value is calculated in consideration of data acquisition, the data transmission rate and the data storage sharing scale at the same time, the information loss value is calculated in consideration of a data acquisition error, and the trust metric of the power Internet of Things is calculated using the information benefit value and the information loss value, and the secure access control to the Internet of Things during a market transaction for the hydro-power unit, the thermal power unit, the nuclear power unit and the air power unit is realized using the trust metric.

### TECHNICAL FIELD

The present application relates to the technical field of power Internet of Things, and in particular, to a method and apparatus for controlling access to power Internet of Things, a non-transitory computer readable storage medium, and a processor.

### BACKGROUND

In the prior art, there are a lot of research efforts in computing the trustworthiness of an access unit on the power Internet of Things, for example, in a credit-based Eigentrust algorithm, a global reputation value of each user is obtained by means of a trust iteration on a user trust chain within a global range, and using the unique reputation value to represent the trust value of the user in the global range, calculating the trust metric of the current node according to the previous transaction feedback evaluation by using a Bayesian probability method, the advantage of the trust-based PeerTrust algorithm lies in that a feedback transaction evaluation is taken into consideration when calculating the trust metric, the recommending trust value of the evaluating node, the time factor of the transaction, and the incentive mechanism of the transaction are five factors affecting the accuracy of the calculation of the trust metric and the anti-attack ability of the algorithm, therefore, the algorithm has a better attack resistance and a weight-based dynamic trust model, research is conducted on the accuracy and anti-attack ability of an algorithm, and the contribution of a time attenuation factor and a punishment excitation factor to the accuracy and anti-attack ability of a confidence calculation is focused on.

In conclusion, in the prior art, in terms of calculation of the trustworthiness of an access unit in the power Internet of Things, a benefit value and a loss value are not considered, which results in a poor control effect of the access of the unit to the power Internet of Things.

### SUMMARY

The present application provides a method and apparatus for controlling access to power Internet of Things, a computer-readable storage medium and a processor.
according to one aspect of the present application, a method for controlling access to power Internet of Things is provided, the method includes: a two-dimensional trapezoidal fuzzy set of acquisition errors of the power/power amount trading response quantity data of the predetermined unit in a predetermined time period is calculated by a statistical analysis method according to power/power amount trading response quantity data of a predetermined unit, a two-dimensional trapezoidal fuzzy set of acquisition errors of the offer data of the predetermined unit in the predetermined time period is calculated by the statistical analysis method according to offer data of the predetermined unit, a two-dimensional trapezoidal fuzzy set of acquisition errors of the transaction price data of the energy market in the predetermined time period is calculated by the statistical analysis method according to transaction price data of an energy market, a two-dimensional trapezoidal fuzzy set of acquisition errors of the power/power amount demand quantity data of the power market in the predetermined time period is calculated by the statistical analysis method according to power/power amount demand quantity data of a power market, a plurality of two-dimensional trapezoidal fuzzy sets of a plurality of fuzzy uncertainties at different levels of the energy trading security check time data in the predetermined time period are calculated by the statistical analysis method according to energy trading security check time data, and the predetermined unit includes a hydro-power unit, a thermal power unit, a nuclear power unit and an air power unit; a plurality of two-dimensional trapezoidal fuzzy sets of a plurality of fuzzy uncertainties at different levels of the data transmission rate data are calculated by the statistical analysis method according to data transmission rate data of an Internet of Things monitoring data center, a plurality of two-dimensional trapezoidal fuzzy sets of a plurality of fuzzy uncertainties at different levels of the data storage sharing scale data are calculated by the statistical analysis method according to data storage sharing scale data of the Internet of Things monitoring data center; a first target acquisition error in the predetermined time period is calculated according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, and a second target acquisition error in the predetermined time period is calculated according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, and the first target acquisition error is an acquisition error of the power/power amount trading response quantity data of the predetermined unit participating in market competition formed in the power Internet of Things, the second target acquisition error is an acquisition error of the offer data of the predetermined unit participating in the market competition formed in the power Internet of Things; a target information benefit value is calculated according to the plurality of two-dimensional trapezoidal fuzzy sets of the plurality of fuzzy uncertainties at different levels of the data transmission rate data, the plurality of two-dimensional trapezoidal fuzzy sets of the plurality of fuzzy uncertainties at different levels of the data storage sharing scale data and an information benefit value formed by the power Internet of Things providing a data acquisition to the predetermined unit in a sensing layer, and the target information benefit value is an information benefit value obtained by the power Internet of Things providing data acquisition, data transmission, data storage and data sharing to the predetermined unit in a market transaction; a first target information loss value is calculated according to the plurality of two-dimensional trapezoidal fuzzy sets of the plurality of fuzzy uncertainties at different levels of the energy trading security check time data in the predetermined time period, the first target acquisition error in the predetermined time period and the second target acquisition error in the predetermined time period; and a second target information loss value is calculated according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period; and a third target information loss value is calculated according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, and the first target information loss value is an information loss value of a market transaction caused by the acquisition errors of the power/power amount transaction response data of the predetermined unit participating in the market competition formed in the power Internet of Things, the acquisition errors of the offer data of the predetermined unit participating in the market competition formed in the power Internet of Things, and the energy trading security check time data in the predetermined time period, the second target information loss value is an information loss value of the market transaction caused by the acquisition errors of the power/power amount trading response quantity data of the predetermined unit participating in the market competition formed in the power Internet of Things in the market transaction, the third target information loss value is an information loss value of the market transaction caused by the acquisition errors of the offer data of the predetermined unit participating in the market competition formed in the power Internet of Things in the market transaction; a trust metric of the power Internet of Things to the predetermined unit is calculated according to the target information benefit value, the first target information loss value, the second target information loss value and the third target information loss value, and access control of the predetermined unit is performed according to the trust metric.

According to another aspect of the present application, an apparatus for controlling access to power Internet of Things is provided. The apparatus includes: a first calculation component, configured to calculate, according to power/power amount trading response quantity data of a predetermined unit, a two-dimensional trapezoidal fuzzy set of acquisition errors of the power/power amount trading response quantity data of the predetermined unit in a predetermined time period by a statistical analysis method, calculate, according to offer data of the predetermined unit, a two-dimensional trapezoidal fuzzy set of acquisition errors of the offer data of the predetermined unit in the predetermined time period by the statistical analysis method, calculate, according to transaction price data of an energy market, a two-dimensional trapezoidal fuzzy set of acquisition errors of the transaction price data of the energy market in the predetermined time period by the statistical analysis method, calculate, according to power/power amount demand quantity data of a power market, a two-dimensional trapezoidal fuzzy set of acquisition errors of the power/power amount demand quantity data of the power market in the predetermined time period by the statistical analysis method, calculate, according to energy trading security check time data, a plurality of two-dimensional trapezoidal fuzzy sets of a plurality of fuzzy uncertainties at different levels of the energy trading security check time data in the predetermined time period by the statistical analysis method; a second calculation component, configured to calculate, according to data transmission rate data of an Internet of Things monitoring data center, a plurality of two-dimensional trapezoidal fuzzy sets of a plurality of fuzzy uncertainties at different levels of the data transmission rate data by the statistical analysis method, calculate, according to data storage sharing scale data of the Internet of Things monitoring data center, a plurality of two-dimensional trapezoidal fuzzy sets of a plurality of fuzzy uncertainties at different levels of the data storage sharing scale data by the statistical analysis method; a third calculation component, configured to calculate a first target acquisition error in the predetermined time period according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, and calculate a second target acquisition error in the predetermined time period according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, and the first target acquisition error is an acquisition error of the power/power amount trading response quantity data of the predetermined unit participating in market competition formed in the power Internet of Things, the second target acquisition error is an acquisition error of the offer data of the predetermined unit participating in the market competition formed in the power Internet of Things; a fourth calculation component, configured to calculate a target information benefit value according to the plurality of two-dimensional trapezoidal fuzzy sets of the plurality of fuzzy uncertainties at different levels of the data transmission rate data, the plurality of two-dimensional trapezoidal fuzzy sets of the plurality of fuzzy uncertainties at different levels of the data storage sharing scale data and an information benefit value formed by the power Internet of Things providing a data acquisition to the predetermined unit in a sensing layer, and the target information benefit value is an information benefit value obtained by the power Internet of Things providing data acquisition, data transmission, data storage and data sharing to the predetermined unit in a market transaction; a fifth calculation component, configured to calculate a first target information loss value according to the plurality of two-dimensional trapezoidal fuzzy sets of the plurality of fuzzy uncertainties at different levels of the energy trading security check time data in the predetermined time period, the first target acquisition error in the predetermined time period and the second target acquisition error in the predetermined time period; and calculate a second target information loss value according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period; and calculate a third target information loss value according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, and the first target information loss value is an information loss value of a market transaction caused by the acquisition errors of the power/power amount transaction response data of the predetermined unit participating in the market competition formed in the power Internet of Things, the acquisition errors of the offer data of the predetermined unit participating in the market competition formed in the power Internet of Things, and the energy trading security check time data in the predetermined time period, the second target information loss value is an information loss value of the market transaction caused by the acquisition errors of the power/power amount trading response quantity data of the predetermined unit participating in the market competition formed in the power Internet of Things in the market transaction, the third target information loss value is an information loss value of the market transaction caused by the acquisition errors of the offer data of the predetermined unit participating in the market competition formed in the power Internet of Things in the market transaction; a sixth calculation component, configured to calculate a trust metric of the power Internet of Things to the predetermined unit according to the target information benefit value, the first target information loss value, the second target information loss value and the third target information loss value, and perform access control of the predetermined unit according to the trust metric.

According to still another aspect of the present application, a computer-readable storage medium is provided. The computer-readable storage medium includes a program stored. When running, the program controls a device where the non-transitory computer readable storage medium is located to execute the method for controlling access to the power Internet of Things in any one of the implementations.

According to another aspect of the present application, a processor is provided, and the processor is configured to run a program, and when running, the program executes the methods for controlling access to the power Internet of Things in any one of the implementations.

### BRIEF DESCRIPTION OF THE DRAWINGS

The accompanying drawings, which form a part of the present application, are used for providing a further understanding of the present application. The schematic embodiments and illustrations of the present application are used for explaining the present application, and do not form improper limits to the present application. In the drawings:

FIG. 1 shows a hardware structure block diagram of a mobile terminal executing a method for controlling access to power Internet of Things according to an embodiment of the present application;

FIG. 2 shows a schematic flowchart of a method for controlling access to the power Internet of Things according to an embodiment of the present application;

FIG. 3 shows a structural block diagram of an apparatus for controlling access control device for the power Internet of Things according to an embodiment of the present application.

### DETAILED DESCRIPTION OF EMBODIMENTS

It is important to note that the embodiments of the present disclosure and the characteristics in the embodiments can be combined under the condition of no conflicts. The present disclosure will be described below with reference to the drawings and embodiments in detail.

To make persons skilled in the art better understand the solutions of the present application, the following clearly and completely describes the technical solutions in the embodiments of the present application with reference to the accompanying drawings in the embodiments of the present application. Apparently, the described embodiments are merely a part rather than all of the embodiments of the present application. All other embodiments obtained by a person of ordinary skill in the art based on the embodiments of the present application without creative efforts shall belong to the scope of protection of the present application.

It should be noted that the terms ‘first’ and ‘second’ in the specification, claims, and accompanying drawings of the present application are used to distinguish similar objects, and are not necessarily used to describe a specific sequence or order. It should be understood that the data so used may be interchanged where appropriate for the embodiments of the present application described herein. In addition, the terms ‘include’ and ‘have’, and any variations thereof, are intended to cover a non-exclusive inclusion, for example, a process, method, system, product, or apparatus that includes a series of steps or units is not necessarily limited to those steps or units that are expressly listed, but may include other steps or units that are not expressly listed or inherent to such process, method, product, or apparatus.

As introduced in the background art, in the prior art, a benefit value and a loss value are not considered in the calculation of the trust metric of an access unit in a power Internet of Things, as a result, the control of the unit access to the power Internet of Things is less effective. In order to solve the problem in the prior art that the benefit value and the loss value are not considered in the calculation of the trust metric of the access unit in a power Internet of Things, as the result, the control of the unit access to the power Internet of Things is less effective, embodiments of the present application provide a method for controlling access to power Internet of Things, an apparatus for controlling access to power Internet of Things and a processor.

The following clearly and completely describes the technical solutions in the embodiments of the present invention with reference to the accompanying drawings in the embodiments of the present invention.

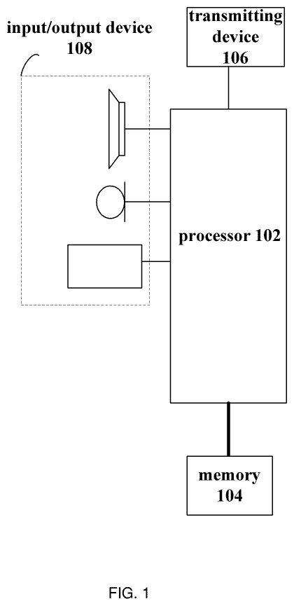

The method embodiments provided in the embodiments of the present application may be implemented in a mobile terminal, a computer terminal, or a similar computing apparatus. Taking the operation on a mobile terminal as an example, FIG. 1 is a hardware structure block diagram of a mobile terminal of a method for controlling access to power Internet of things according to an embodiment of the present invention. As shown in FIG. 1, the mobile terminal may include one or more (only one is shown in FIG. 1) processors 102 (the processors 102 may include, but are not limited to, a processing apparatus such as a microprocessor MCU or a programmable logic device FPGA) and a memory 104 for storing data, and the mobile terminal can further include a transmitting device 106 and an input/output device 108 for a communication function. A person of ordinary skill in the art may understand that the structure shown in FIG. 1 is merely exemplary, which does not limit the structure of the foregoing mobile terminal. For example, the mobile terminal may further include more or less components than shown in FIG. 1, or have a different configuration from that shown in FIG. 1.

The memory 104 may be configured to store a computer program, for example, a software program and a component of application software, such as a computer program corresponding to the device information display method in the embodiment of the present invention. The processor 102 runs the computer program stored in the memory 104, so as to execute various function applications and data processing, that is, implement the foregoing method. Memory 104 may include high-speed random access memory, and may also include non-volatile memory, such as one or more magnetic storage devices, flash memory, or other non-volatile solid-state memory. In some instances, memory 104 may further include memory remotely located with respect to processor 102, which may be connected to mobile terminals over a network. Examples of such networks include, but are not limited to, the Internet, intranets, local area networks, mobile communication networks, and combinations thereof. The transmitting device 106 is configured to receive or transmit data via a network. Specific examples of the described network may include a wireless network provided by a communication provider of the mobile terminal. In one example, the transmitting device 106 may include a Network Interface Controller (NIC) that may be coupled to other network devices via a base station to communicate with the Internet. In one example, the transmitting device 106 can be a Radio Frequency (RF) component for communicating wirelessly with the Internet.

The embodiment provides a method for controlling access to power Internet of Things running on a mobile terminal, a computer terminal or a similar computing apparatus. It should be noted that the steps shown in the flowchart of the figure can be executed in a computer system such as a group of computer executable instructions. In addition, although the logic order is shown in the flowchart, in some cases, the shown or described steps can be executed in an order different from that described here.

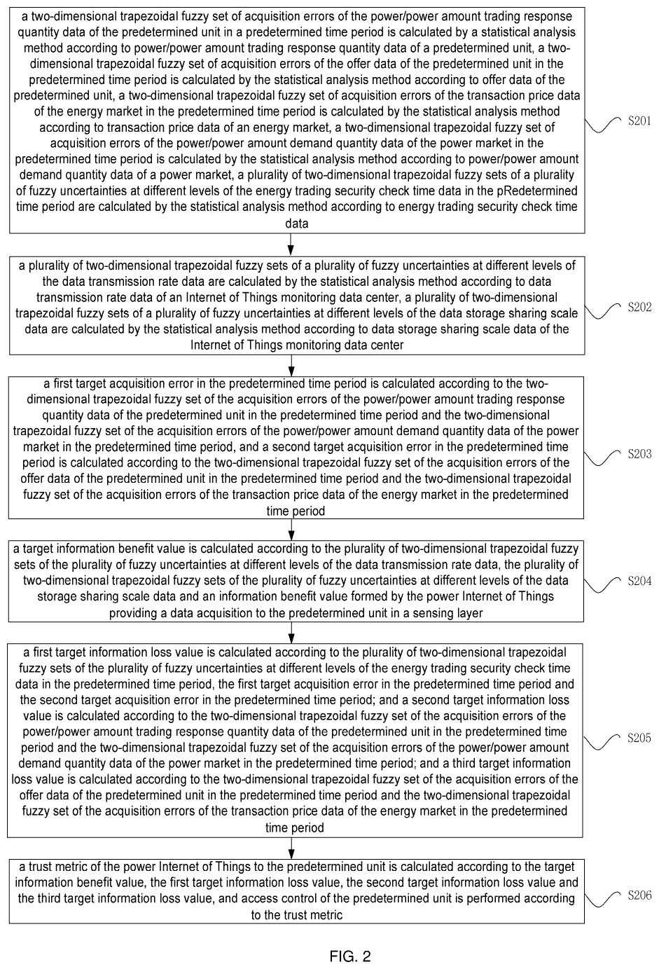

FIG. 2 is a flowchart of a method for controlling access to power Internet of Things according to an embodiment of the present application. As shown in FIG. 2, the method includes the following steps.

Step S201, a two-dimensional trapezoidal fuzzy set of acquisition errors of the power/power amount trading response quantity data of the predetermined unit in a predetermined time period is calculated by a statistical analysis method according to power/power amount trading response quantity data of a predetermined unit, a two-dimensional trapezoidal fuzzy set of acquisition errors of the offer data of the predetermined unit in the predetermined time period is calculated by the statistical analysis method according to offer data of the predetermined unit, a two-dimensional trapezoidal fuzzy set of acquisition errors of the transaction price data of the energy market in the predetermined time period is calculated by the statistical analysis method according to transaction price data of an energy market, a two-dimensional trapezoidal fuzzy set of acquisition errors of the power/power amount demand quantity data of the power market in the predetermined time period is calculated by the statistical analysis method according to power/power amount demand quantity data of a power market, a plurality of two-dimensional trapezoidal fuzzy sets of a plurality of fuzzy uncertainties at different levels of the energy trading security check time data in the predetermined time period are calculated by the statistical analysis method according to energy trading security check time data.

And, the predetermined unit includes a hydro-power unit, a thermal power unit, a nuclear power unit and an air power unit.

Specifically, the power/power amount trading response quantity data includes a bidding power and bidding electric quantity of each period of a cycle (such as a 24*4*15 period of a day) submitted by each power generation plant in each region to a transaction center.

In particular, the offer data includes a bidding price corresponding to a bidding power and bidding electric quantity of each period of a cycle (such as a 24*4*15 period of a day) submitted by each power generation plant in each region to the transaction center.

In particular, the transaction price data includes a data set of transaction prices for each period decided by the market.

Specifically, the power/power amount demand quantity data includes a data set of a bidding power and bidding electric quantity of each period of a cycle (such as a 24*4*15 period of a day) submitted by each power generation plant in each region to a transaction center according to the power generation capability and the profitability expectation of the power generation plant.

In particular, the energy trading security check time refers to the security check-in time of the power market capacity trading data formed for different market trading data scales and network transmission rates.

Step S202, a plurality of two-dimensional trapezoidal fuzzy sets of a plurality of fuzzy uncertainties at different levels of the data transmission rate data are calculated by the statistical analysis method according to data transmission rate data of an Internet of Things monitoring data center, a plurality of two-dimensional trapezoidal fuzzy sets of a plurality of fuzzy uncertainties at different levels of the data storage sharing scale data are calculated by the statistical analysis method according to data storage sharing scale data of the Internet of Things monitoring data center.

Specifically, the data storage sharing scale refers to the amount of data that is stored and shared, the data transmission rate refers to a data transmission rate that adapts to the data scale, and the data storage sharing scale data refers to the size and magnitude of the amount of data that is stored on a platform and shared within a certain range.

Step S203, a first target acquisition error in the predetermined time period is calculated according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, and a second target acquisition error in the predetermined time period is calculated according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period.

And the first target acquisition error is an acquisition error of the power/power amount trading response quantity data of the predetermined unit participating in market competition formed in the power Internet of Things, the second target acquisition error is an acquisition error of the offer data of the predetermined unit participating in the market competition formed in the power Internet of Things; Step S204, a target information benefit value is calculated according to the plurality of two-dimensional trapezoidal fuzzy sets of the plurality of fuzzy uncertainties at different levels of the data transmission rate data, the plurality of two-dimensional trapezoidal fuzzy sets of the plurality of fuzzy uncertainties at different levels of the data storage sharing scale data and an information benefit value formed by the power Internet of Things providing a data acquisition to the predetermined unit in a sensing layer.

And the target information benefit value is an information benefit value obtained by the power Internet of Things providing data acquisition, data transmission, data storage and data sharing to the predetermined unit in a market transaction;

Step S205, a first target information loss value is calculated according to the plurality of two-dimensional trapezoidal fuzzy sets of the plurality of fuzzy uncertainties at different levels of the energy trading security check time data in the predetermined time period, the first target acquisition error in the predetermined time period and the second target acquisition error in the predetermined time period; and a second target information loss value is calculated according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period; and a third target information loss value is calculated according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period.

And the first target information loss value is an information loss value of a market transaction caused by the acquisition errors of the power/power amount transaction response data of the predetermined unit participating in the market competition formed in the power Internet of Things, the acquisition errors of the offer data of the predetermined unit participating in the market competition formed in the power Internet of Things, and the energy trading security check time data in the predetermined time period, the second target information loss value is an information loss value of the market transaction caused by the acquisition errors of the power/power amount trading response quantity data of the predetermined unit participating in the market competition formed in the power Internet of Things in the market transaction, the third target information loss value is an information loss value of the market transaction caused by the acquisition errors of the offer data of the predetermined unit participating in the market competition formed in the power Internet of Things in the market transaction;

Step S206: a trust metric of the power Internet of Things to the predetermined unit is calculated according to the target information benefit value, the first target information loss value, the second target information loss value and the third target information loss value, and access control of the predetermined unit is performed according to the trust metric.

By means of the described embodiments, the information benefit value is calculated in consideration of data acquisition, the data transmission rate and the data storage sharing scale at the same time, the information loss value is calculated in consideration of a data acquisition error, and the trust metric of the power Internet of Things is calculated using the information benefit value and the information loss value, and the secure access control to the Internet of Things during a market transaction for the hydro-power unit, the thermal power unit, the nuclear power unit and the air power unit is realized using the trust metric, thereby solving the problem in the prior art that a benefit value and a loss value are not considered in the calculation of the trust metric of an access unit in a power Internet of Things, as a result, the control of the unit access to the power Internet of Things is less effective.

In an optional implementation, in the predetermined time period, the two-dimensional trapezoidal fuzzy set of the acquisition errors of the power/power amount trading response quantity data of the predetermined unit is:

$${e}_{RPH}^{t} = ( {e}_{RPHL}^{t} , {e}_{RPHU}^{t} ) = [ ( {e}_{RPHL 1}^{t} , {e}_{RPHL 2}^{t} , {e}_{RPHL 3}^{t} , {e}_{RPHL 4}^{t} ; {k}_{eRPHL}^{t} ) , ( {e}_{RPHU 1}^{t} , {e}_{RPHU 2}^{t} , {e}_{RPHU 3}^{t} , {e}_{RPHU 4}^{t} ; {k}_{eRPHU}^{t} ) ] ;$$

$${e}_{RPT}^{t} = ( {e}_{RPTL}^{t} , {e}_{RPTU}^{t} ) = [ ( {e}_{RPTL 1}^{t} , {e}_{RPTL 2}^{t} , {e}_{RPTL 3}^{t} , {e}_{RPTL 4}^{t} ; {k}_{eRPTL}^{t} ) , ( {e}_{RPTU 1}^{t} , {e}_{RPTU 2}^{t} , {e}_{RPTU 3}^{t} , {e}_{RPTU 4}^{t} ; {k}_{eRPTU}^{t} ) ] ;$$

$${e}_{RPN}^{t} = ( {e}_{RPNL}^{t} , {e}_{RPNU}^{t} ) = [ ( {e}_{RPNL 1}^{t} , {e}_{RPNL 2}^{t} , {e}_{RPNL 3}^{t} , {e}_{RPNL 4}^{t} ; {k}_{eRPNL}^{t} ) , ( {e}_{RPNU 1}^{t} , {e}_{RPNU 2}^{t} , {e}_{RPNU 3}^{t} , {e}_{RPNU 4}^{t} ; {k}_{eRPNU}^{t} ) ] ;$$

$${e}_{RPG}^{t} = ( {e}_{RPGL}^{t} , {e}_{RPGU}^{t} ) = [ ( {e}_{RPGL 1}^{t} , {e}_{RPGL 2}^{t} , {e}_{RPGL 3}^{t} , {e}_{RPGL 4}^{t} ; {k}_{eRPGL}^{t} ) , ( {e}_{RPGU 1}^{t} , {e}_{RPGU 2}^{t} , {e}_{RPGU 3}^{t} , {e}_{RPGU 4}^{t} ; {k}_{eRPGU}^{t} ) ] ;$$

and t is the predetermined time period, e_{RPH}^{t} is the two-dimensional trapezoidal fuzzy set of the acquisition errors of the power/power amount trading response quantity data of the hydro-power unit in the predetermined time period, e_{RPHL}^{t} is a fuzzy number corresponding to a lower bound of a two-dimensional trapezoidal fuzzy set of acquisition errors of the power/power amount trading response quantity data of the hydro-power unit in the predetermined period, k_{eRPHL}^{t} is a membership coefficient of a fuzzy number corresponding to the lower bound of the two-dimensional trapezoidal fuzzy set of the acquisition errors of the power/power amount trading response quantity data of the hydro-power unit in the predetermined period, e_{RPHUj}^{t} is a fuzzy number corresponding to an upper bound of the two-dimensional trapezoidal fuzzy set of the acquisition errors of the power/power amount trading response quantity data of the hydro-power unit in the predetermined period, k_{eRPHU}^{t} is a membership coefficient of the fuzzy number corresponding to the upper bound of the two-dimensional trapezoidal fuzzy set of the acquisition errors of the power/power amount trading response quantity data of the hydro-power unit in the predetermined period, e_{RPT}^{t} is the two-dimensional trapezoidal fuzzy set of the acquisition errors of the power/power amount trading response quantity data of the thermal power unit in the predetermined time period, e_{RPTLj}^{t} is a fuzzy number corresponding to a lower bound of the two-dimensional trapezoidal fuzzy set of the acquisition errors of the power/power amount trading response quantity data of the thermal power unit in the predetermined time period, k_{eRPTL}^{t} is a membership coefficient of the fuzzy number corresponding to the lower bound of the two-dimensional trapezoidal fuzzy set of the acquisition errors of the power/power amount trading response quantity data of the thermal power unit in the predetermined period, e_{RPTUj}^{t} is a fuzzy number corresponding to an upper bound of the two-dimensional trapezoidal fuzzy set of the acquisition errors of the power/power amount trading response quantity data of the thermal power unit in the predetermined time period, k_{eRPTUj}^{t} is a membership coefficient of the fuzzy number corresponding to the upper bound of the two-dimensional trapezoidal fuzzy set of the acquisition errors of the power/power amount trading response quantity data of the thermal power unit in the predetermined period, e_{RPN}^{t} is the two-dimensional trapezoidal fuzzy set of the acquisition errors of the power/power amount trading response quantity data of the nuclear power unit in the predetermined time period, e_{RPNLj}^{t} is a fuzzy number corresponding to a lower bound of the two-dimensional trapezoidal fuzzy set of the acquisition errors of the power/power amount trading response quantity data of the nuclear power unit in the predetermined period, k_{eRPNL}^{t} is a membership coefficient of the fuzzy number corresponding to the lower bound of the two-dimensional trapezoidal ambiguous set of acquisition errors of the power/power amount trading response quantity data of the nuclear power unit in the predetermined time period, e_{RPNUj}^{t} is a fuzzy number corresponding to an upper bound of the two-dimensional trapezoidal fuzzy set of the acquisition errors of the power/power amount trading response quantity data of the nuclear power unit in the predetermined period, k_{eRPNU}^{t} is a membership coefficient of the fuzzy number corresponding to the upper bound of the two-dimensional trapezoidal fuzzy set of the acquisition errors of the power/power amount trading response quantity data of the nuclear power unit in the predetermined time period, e_{RPG}^{t} is the two-dimensional trapezoidal fuzzy set of the acquisition errors of the power/power amount trading response quantity data of the air power unit in the predetermined time period, e_{RPGLj}^{t} is a fuzzy number corresponding to a lower bound of the two-dimensional trapezoidal fuzzy set of the acquisition errors of the power/power amount trading response quantity data of the air power unit in the predetermined time period, k_{eRPGL}^{t} is a membership coefficient of the fuzzy number corresponding to the lower bound of the two-dimensional trapezoidal fuzzy set of the acquisition errors of the power/power amount trading response quantity data of the air power unit in the predetermined time period, e_{RPGUj}^{t} is a fuzzy number corresponding to an upper bound of the two-dimensional trapezoidal fuzzy set of the acquisition errors of the power/power amount trading response quantity data of the air power unit in the predetermined time period, k_{eRPGU}^{t} is a membership coefficient of the fuzzy number corresponding to the upper bound of the two-dimensional trapezoidal fuzzy set of the acquisition errors of the power/power amount trading response quantity data of the air power unit in the predetermined time period, t=1, 2, . . . , N_{RP}, j=1, 2, 3, 4;
the two-dimensional trapezoidal fuzzy set of the acquisition errors of the offer data of the predetermined unit in the predetermined time period is:

$${e}_{RpH}^{t} = ( {e}_{RpHL}^{t} , {e}_{RpHU}^{t} ) = [ ( {e}_{RpHL 1}^{t} , {e}_{RpHL 2}^{t} , {e}_{RpHL 3}^{t} , {e}_{RpHL 4}^{t} ; {k}_{eRpHL}^{t} ) , ( {e}_{RpHU 1}^{t} , {e}_{RpHU 2}^{t} , {e}_{RpHU 3}^{t} , {e}_{RpHU 4}^{t} ; {k}_{eRpHU}^{t} ) ] ;$$

$${e}_{RpT}^{t} = ( {e}_{RpTL}^{t} , {e}_{RpTU}^{t} ) = [ ( {e}_{RpTL 1}^{t} , {e}_{RpTL 2}^{t} , {e}_{RpTL 3}^{t} , {e}_{RpTL 4}^{t} ; {k}_{eRpTL}^{t} ) , ( {e}_{RpTM 1}^{t} , {e}_{RpTM 2}^{t} , {e}_{RpTM 3}^{t} , {e}_{RpTM 4}^{t} ; {k}_{eRpTM}^{t} ) ] ;$$

$${e}_{RpN}^{t} = ( {e}_{RpNL}^{t} , {e}_{RpNU}^{t} ) = [ ( {e}_{RpNL 1}^{t} , {e}_{RpNL 2}^{t} , {e}_{RpNL 3}^{t} , {e}_{RpNL 4}^{t} ; {k}_{eRpNL}^{t} ) , ( {e}_{RpNU 1}^{t} , {e}_{RpNU 2}^{t} , {e}_{RpNU 3}^{t} , {e}_{RpNU 4}^{t} ; {k}_{eRpNU}^{t} ) ] ;$$

$${e}_{RpG}^{t} = ( {e}_{RpGL}^{t} , {e}_{RpGU}^{t} ) = [ ( {e}_{RpGL 1}^{t} , {e}_{RpGL 2}^{t} , {e}_{RpGL 3}^{t} , {e}_{RpGL 4}^{t} ; {k}_{eRpGL}^{t} ) , ( {e}_{RpGU 1}^{t} , {e}_{RpGU 2}^{t} , {e}_{RpGU 3}^{t} , {e}_{RpGU 4}^{t} ; {k}_{eRpGU}^{t} ) ] ;$$

and e_{RpH}^{t} is the two-dimensional trapezoidal fuzzy set of the acquisition errors of the offer data of the hydro-power unit in the predetermined time period, e_{RpHj}^{t} is a fuzzy number corresponding to a lower bound of the two-dimensional trapezoidal fuzzy set of the acquisition errors of the offer data of the hydro-power unit in the predetermined period, k_{eRpHL}^{t} a membership coefficient of the fuzzy number corresponding to the lower bound of the two-dimensional trapezoidal fuzzy set of the acquisition errors of the offer data of the hydro-power unit in the predetermined time period, is a fuzzy number corresponding to an upper bound of the two-dimensional trapezoidal fuzzy set of the acquisition errors of the offer data of the hydro-power unit in the predetermined period, e_{RpHUj}^{t} is a membership coefficient of the fuzzy number corresponding to the upper bound of the two-dimensional trapezoidal fuzzy set of the acquisition errors of the offer data of the hydro-power unit in the predetermined period, e_{RpT}^{t} is the two-dimensional trapezoidal fuzzy set of the acquisition errors of the offer data of the thermal power unit in the predetermined time period, e_{RpTLj}^{t} is a fuzzy number corresponding to a lower bound of the two-dimensional trapezoidal fuzzy set of the acquisition errors of the offer data of the thermal power unit in the predetermined time period, k_{eRpTL}^{t} is a membership coefficient of the fuzzy number corresponding to the lower bound of the two-dimensional trapezoidal fuzzy set of the acquisition errors of the offer data of the thermal power unit in the predetermined time period, e_{RpTUj}^{t} is a fuzzy number corresponding to an upper bound of the two-dimensional trapezoidal fuzzy set of the acquisition errors of the offer data of the thermal power unit in the predetermined time period, k_{eRpTU}^{t} is a membership coefficient of the fuzzy number corresponding to the upper bound of the two-dimensional trapezoidal fuzzy set of the acquisition errors of the offer data of the thermal power unit in the predetermined time period, e_{RpN}^{t} is the two-dimensional trapezoidal fuzzy set of the acquisition errors of the offer data of the nuclear power unit in the predetermined time period, e_{RpNTj}^{t} is a fuzzy number corresponding to a lower bound of the two-dimensional trapezoidal fuzzy set of the acquisition errors of the offer data of the nuclear power unit in the predetermined time period, k_{eRpNL}^{t} is a membership coefficient of the fuzzy number corresponding to the lower bound of the two-dimensional trapezoidal fuzzy set of the acquisition errors of the offer data of the nuclear power unit in the predetermined time period, e_{RpNUj}^{t} is a fuzzy number corresponding to an upper bound of the two-dimensional trapezoidal fuzzy set of the acquisition errors of the offer data of the nuclear power unit in the predetermined time period, k_{eRPU}^{t} is a membership coefficient of the fuzzy number corresponding to the upper bound of the two-dimensional trapezoidal fuzzy set of the acquisition errors of the offer data of the nuclear power unit in the predetermined period, e_{RpG}^{t} is the two-dimensional trapezoidal fuzzy set of the acquisition errors of the offer data of the air power unit in the predetermined time period, e_{RpGLj}^{t} is a fuzzy number corresponding to a lower bound of the two-dimensional trapezoidal fuzzy set of the acquisition errors of the offer data of the air power unit in the predetermined time period, k_{eRpGL}^{t} is a membership coefficient of the fuzzy number corresponding to the lower bound of the two-dimensional trapezoidal fuzzy set of the acquisition error of the offer data of the air power unit in the predetermined time period, e_{RpGUj}^{t} is a fuzzy number corresponding to an upper bound of the two-dimensional trapezoidal fuzzy set of the acquisition errors of the offer data of the air power unit in the predetermined time period, k_{eRpGU}^{t} is a membership coefficient of the fuzzy number corresponding to the upper bound of the two-dimensional trapezoidal fuzzy set of the acquisition errors of the offer data of the air power unit in the predetermined time period;
the two-dimensional trapezoidal fuzzy set of the acquisition errors of the transaction price data of the energy market in the predetermined time period is:

$${e}_{Rp}^{t} = ( {e}_{RpL}^{t} , {e}_{RpU}^{t} ) = [ ( {e}_{RpL 1}^{t} , {e}_{RpL 2}^{t} , {e}_{RpL 3}^{t} , {e}_{RpL 4}^{t} ; {k}_{eRpL}^{t} ) , ( {e}_{RpU 1}^{t} , {e}_{RpU 2}^{t} , {e}_{RpU 3}^{t} , {e}_{RpU 4}^{t} ; {k}_{eRpU}^{t} ) ] ;$$

and e_{Rp}^{t}, is the two-dimensional trapezoidal fuzzy set of the acquisition errors of the transaction price data of the energy market in the predetermined time period, M is a fuzzy number corresponding to a lower bound of the two-dimensional trapezoidal fuzzy set of the acquisition errors of the transaction price data of the energy market in the predetermined time period, k_{cRpL}^{t} is a membership coefficient of the fuzzy number corresponding to the lower bound of the two-dimensional trapezoidal fuzzy set of the acquisition errors of the transaction price data of the energy market in the predetermined time period, e_{RpUj}^{t} is a fuzzy number corresponding to an upper bound of the two-dimensional trapezoidal fuzzy set of the acquisition errors of the transaction price data of the energy market in the predetermined time period, k_{eRpU}^{t} is a membership coefficient of the fuzzy number corresponding to the upper bound of the two-dimensional trapezoidal fuzzy set of the acquisition errors of the transaction price data of the energy market in the predetermined time period;
the two-dimensional trapezoidal fuzzy set of the acquisition errors of the power/power amount demand quantity data of the power market in the predetermined time period is:

$${e}_{RP}^{t} = ( {e}_{RPL}^{t} , {e}_{RPU}^{t} ) = [ ( {e}_{RPL 1}^{t} , {e}_{RPL 2}^{t} , {e}_{RPL 3}^{t} , {e}_{RPL 4}^{t} ; {k}_{eRPL}^{t} ) , ( {e}_{RPU 1}^{t} , {e}_{RPU 2}^{t} , {e}_{RPU 3}^{t} , {e}_{RPU 4}^{t} ; {k}_{eRPU}^{t} ) ] ;$$

and e_{RP}^{t} is the two-dimensional trapezoidal fuzzy set of the acquisition errors of the power/power amount demand quantity data of the power market in the predetermined period, e_{RPLj}^{t} is a fuzzy number corresponding to a lower bound of the two-dimensional trapezoidal fuzzy set of the acquisition errors of the power/power amount demand quantity data of the power market in the predetermined period, k_{eRPL}^{t} is a membership coefficient of the fuzzy number corresponding to the lower bound of the two-dimensional trapezoidal fuzzy set of the acquisition errors of the power/power amount demand quantity data of the power market in the predetermined time period, e_{RPUj}^{t} is a fuzzy number corresponding to an upper bound of the two-dimensional trapezoidal fuzzy set of the acquisition errors of the power/power amount demand quantity data of the power market in the predetermined period, k_{eRPU}^{t} is a membership coefficient of the fuzzy number corresponding to the upper bound of the two-dimensional trapezoidal fuzzy set of the acquisition errors of the power/power amount demand quantity data of the power market in the predetermined time period;
the plurality of two-dimensional trapezoidal fuzzy sets of the plurality of fuzzy uncertainties at different levels of the energy trading security check time data in the predetermined time period is:

$${T}_{Si} = ( {T}_{SiL} , {T}_{SiU} ) = [ ( {T}_{SiL 1} , {T}_{SiL 2} , {T}_{SiL 3} , {T}_{SiL 4} ; {k}_{TSiL} ) , ( {T}_{SiU 1} , {T}_{SiU 2} , {T}_{SiU 3} , {T}_{SiU 4} ; {k}_{TSiU} ) ] ;$$

and, T_{SV} is a ith two-dimensional trapezoidal fuzzy set of the energy trading security check time data, and T_{SiL} is a fuzzy number corresponding to a lower bound of the two-dimensional trapezoidal fuzzy set of a ith fuzzy uncertainty of the energy trading security check time data, k_{TSiL} is a membership coefficient of the fuzzy number corresponding to the lower bound of the two-dimensional trapezoidal fuzzy set of the ith fuzzy uncertainty of the energy trading security check time data, T_{SiU} is a fuzzy number corresponding to an upper bound of the two-dimensional trapezoidal fuzzy set of the ith fuzzy uncertainty of the energy trading security check time data, k_{TSiU} is a membership coefficient of the fuzzy number corresponding to the upper bound of the two-dimensional trapezoidal fuzzy set of the ith fuzzy uncertainty of the energy trading security check time data.

In an optional implementation, the plurality of two-dimensional trapezoidal fuzzy sets of the plurality of fuzzy uncertainties at different levels of the data transmission rate data are calculated by the statistical analysis method according to the data transmission rate data of the Internet of Things monitoring data center, the plurality of two-dimensional trapezoidal fuzzy sets of the plurality of fuzzy uncertainties at different levels of the data storage sharing scale data are calculated by the statistical analysis method according to the data storage sharing scale data of the Internet of Things monitoring data center includes:
according to the data transmission rate data of the Internet of Things monitoring data center, the plurality of two-dimensional trapezoidal fuzzy sets of nine fuzzy uncertainties of extremely low, very low, low, slightly low, medium, slightly high, high, very high and extremely high of the data transmission rate data are respectively calculated by the statistical analysis method:

$${v}_{Di} = ( {v}_{DiL} , {v}_{DiU} ) = [ ( {v}_{DiL 1} , {v}_{DiL 2} , {v}_{DiL 3} , {v}_{DiL 4} ; {k}_{DviL} ) , ( {v}_{DiU 1} , {v}_{DiU 2} , {v}_{DiU 3} , {v}_{DiU 4} ; {k}_{DviU} ) ] ;$$

$$i = 1 , 2 , … , 9 ;$$

and v_{Di} is a ith two-dimensional trapezoidal fuzzy set of the data transmission rate data, v_{DIL} is a fuzzy number corresponding to a lower bound of the two-dimensional trapezoidal fuzzy set of a ith fuzzy uncertainty of the data transmission rate data; k_{DviL} is a membership coefficient of the fuzzy number corresponding to the lower bound of the two-dimensional trapezoidal fuzzy set of the ith fuzzy uncertainty of the data transmission rate data, v_{DiU} is a fuzzy number corresponding to an upper bound of the two-dimensional trapezoidal fuzzy set of the ith fuzzy uncertainty of the data transmission rate data, and k_{DviU} is a membership coefficient of the fuzzy number corresponding to the upper bound of the two-dimensional trapezoidal fuzzy set of the ith fuzzy uncertainty of the data transmission rate data;
according to the data storage sharing scale data of the Internet of Things monitoring data center, the plurality of two-dimensional trapezoidal fuzzy sets of nine fuzzy uncertainties of extremely low, very low, low, slightly low, medium, slightly high, high, very high and extremely high of the data storage sharing scale data are respectively calculated by the statistical analysis method:

$${S}_{Di} = ( {S}_{\text{?}} , {S}_{\text{?}} ) = [ ( {S}_{\text{?}} , {S}_{\text{?}} , {S}_{\text{?}} , {S}_{\text{?}} ; {k}_{\text{?}} ) , ( {S}_{\text{?}} , {S}_{\text{?}} , {S}_{\text{?}} , {S}_{\text{?}} ; {k}_{\text{?}} ) ] ;$$

$$\text{?} \text{indicates text missing or illegible when filed}$$

and, S_{Di} is a ith two-dimensional trapezoidal fuzzy set of the data storage sharing scale data, S_{DiL} is a fuzzy number corresponding to a lower bound of the two-dimensional trapezoidal fuzzy set of a ith fuzzy uncertainty of the data storage sharing scale data, k_{DSiL} is a membership coefficient of the fuzzy number corresponding to the lower bound of the two-dimensional trapezoidal fuzzy set of the ith fuzzy uncertainty of the data storage sharing scale data, S_{DiU} is a fuzzy number corresponding to an upper bound of the two-dimensional trapezoidal fuzzy set of the ith fuzzy uncertainty of the data storage sharing scale data, and k_{DSiU} is a membership coefficient of the fuzzy number corresponding to the upper bound of the two-dimensional trapezoidal fuzzy set of the ith fuzzy uncertainty of the data storage sharing scale data.

In an optional implementation, according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, the first target acquisition error in the predetermined time period is calculated, and according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, the second target acquisition error in the predetermined time period is calculated includes:
according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, the first target acquisition error in the predetermined time period is calculated:

$${e}_{P}^{i} = E [ {e}_{RP}^{i} ⊗ ( {e}_{RPH}^{i} + {e}_{RPT}^{i} + {e}_{RPN}^{i} + {e}_{RPG}^{i} ) ] ;$$

and, E[ ] represents a expected value to be taken in [ ], and ⊗ represents a union of fuzzy sets;

Specifically, acquisition errors of power/power amount trading response quantity data of the hydro-power unit, the thermal power unit, the nuclear power unit and the air power unit participating in market competition in the internet of power Internet of Things are determined by acquisition errors of power/power amount demand quantity and acquisition errors of output power amounts of various generator units, and the acquisition errors of the output power amounts of various generator units include an output power amount of the hydro-power unit participating in the market competition, an output power amount of the thermal power unit participating in the market competition, an output power amount of the nuclear power unit participating in the market competition and an acquisition error of the output power amount of the air power unit participating in the market competition.
according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, the second target acquisition error in the predetermined time period is calculated:

$${e}_{p}^{i} = E [ {e}_{Rp}^{i} ⊗ ( {e}_{RpH}^{i} + {e}_{RpT}^{i} + {e}_{RpN}^{i} + {e}_{RpG}^{i} ) ] .$$

Specifically, the acquisition errors of units offer of participating market competition formed in the power Internet of Things is determined by an acquisition error of energy market transaction price data and the acquisition error of the offer of various generator units.

Acquisition errors of various generator units include the offer of hydro-power units participating in market competition, the offer of thermal power units participating in market competition, the offer of nuclear power units participating in market competition, and the offer of air power units participating in market competition.

In an optional embodiment, according to the plurality of two-dimensional trapezoidal fuzzy sets of the plurality of fuzzy uncertainties at different levels of the data transmission rate data, the plurality of two-dimensional trapezoidal fuzzy sets of the plurality of fuzzy uncertainties at different levels of the data storage sharing scale data and the information benefit value formed by the power Internet of Things providing the data acquisition to the predetermined unit in the sensing layer, the target information benefit value is calculated includes:
the plurality of two-dimensional trapezoidal fuzzy sets of the plurality of fuzzy uncertainties at different levels of the data transmission rate data, the plurality of two-dimensional trapezoidal fuzzy sets of the plurality of fuzzy uncertainties at different levels of the data storage sharing scale data, and the information benefit value formed by the power Internet of Things providing the data acquisition to the predetermined unit in the sensing layer are substituted into a target information benefit value calculation formula, and the target information benefit value is calculated;
the target information benefit value calculation formula is:

$${R}_{RP} = E [ {{∨}^{9}}_{i = 1} {k}_{Di} {v}_{Dvi} ⊗ {{∨}^{9}}_{i = 1} {k}_{DSi} {S}_{Di} ⊗ {k}_{Mi} ( {M}_{H} + {M}_{T} + {M}_{N} + {M}_{G} ) ] ;$$

and, R_{RP} is the target information benefit value,

$${{∨}^{9}}_{i = 1} {k}_{Di} {v}_{Dvi}$$

is an information benefit value formed when the power Internet of Things provides the data transmission rate data at nine fuzzy uncertainties rates of extremely low, very low, low, slightly low, medium, slightly high, high, very high and extremely high to the predetermined unit, k_{Dvi} is a unit benefit value brought to the predetermined unit due to the power Internet of Things providing the data transmission rate data at a ith rate,

$${{∨}^{9}}_{i = 1} {k}_{DSi} {S}_{Di}$$

is an information benefit value formed when the power Internet of Things providing the data storage sharing scale data of nine fuzzy uncertainties scales of extremely low, very low, low, slightly low, medium, slightly high, high, very high and extremely high to the predetermined unit, k_{DSi} is a unit benefit value brought to the predetermined unit due to the power Internet of Things providing the data storage sharing scale data at the ith rate, k_{Mi}M_{H} is an information benefit value formed when the power Internet of Things provides the data acquisition to the hydro-power unit in the sensing layer k_{Mi}M_{T} is an information benefit value formed when the power Internet of Things providing the data acquisition to the thermal power unit in the sensing layer, k_{Mi}M_{N} is an information benefit value formed when the power acquisition layer provides the data acquisition to the nuclear power unit in the sensing layer, k_{Mi}M_{G} is an information benefit value when the power acquisition layer provides the data acquisition to the air power unit in the sensing layer, and k_{Mi} is a unit benefit value brought to the predetermined unit due to the power Internet of Things providing the data acquisition for the predetermined unit in the sensing layer. E[ ] is a expected value to be taken in [ ],

$${{∨}^{9}}_{\text{?} = 1}$$

$$\text{?} \text{indicates text missing or illegible when filed}$$

represents a union of nine fuzzy sets.

Specifically, M_{H}, M_{T}, M_{N} and M_{G} may be represented by a two-dimensional trapezoid fuzzy set, and the specific formula is as follows:

M_{H}=(M_{H1},M_{H2},M_{H3},M_{H4};k_{H});

M_{T}=(M_{T1},M_{T2},M_{T3},M_{T4};k_{T});

M_{N}=(M_{N1},M_{N2},M_{N3},M_{N4};k_{N});

M_{G}=(M_{G1},M_{G2},M_{G3},M_{G4};k_{G});

in the formula, M_{H} is a two-dimensional trapezoidal fuzzy set at a data acquisition scale provided for the hydro-power unit in a sensing layer by the power Internet of Things, and, M_{H1}, M_{H2}, M_{H3}, M_{H4} and k_{H} are a fuzzy set and a membership coefficient thereof respectively of the two-dimensional trapezoidal fuzzy set at the data acquisition scale provided for the hydro-power unit in the sensing layer by the power Internet of Things; M_{T} is a two-dimensional trapezoidal fuzzy set at a data acquisition scale provided for the thermal power unit in the sensing layer by the power Internet of Things, M_{T1}, M_{T2}, M_{T3}, M_{T4} and k_{T} are a fuzzy set and a membership coefficient thereof respectively of the two-dimensional trapezoidal fuzzy set at the data acquisition scale provided for the thermal power unit by the power Internet of Things in the sensing layer, M_{N} is a two-dimensional trapezoidal fuzzy set at a data acquisition scale provided for a nuclear power unit in a sensing layer of the power Internet of Things, M_{N1}, M_{N2}, M_{N3}, M_{N4} and k_{N} are a fuzzy set and a membership coefficient thereof respectively of the two-dimensional trapezoidal fuzzy set at the data acquisition scale provided for the nuclear power unit by the power Internet of Things in the sensing layer, M_{G} is a two-dimensional trapezoidal fuzzy set at a data acquisition scale provided for an air power unit by the power Internet of Things in the sensing layer, and M_{G1}, M_{G2}, M_{G3}, M_{G4} and k_{G} are a fuzzy set and a membership coefficient thereof respectively of the two-dimensional trapezoidal fuzzy set at the data acquisition scale provided for the air power unit by the power Internet of Things in the sensing layer.

In an optional implementation, according to the plurality of two-dimensional trapezoidal fuzzy sets of the plurality of fuzzy uncertainties at different levels of the energy trading security check time data in the predetermined time period, the first target acquisition error in the predetermined time period and the second target acquisition error in the predetermined time period, the first target information loss value is calculated; and according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, the second target information loss value is calculated; and according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, the third target information loss value is calculated includes:
the plurality of two-dimensional trapezoidal fuzzy sets of the plurality of fuzzy uncertainties at different levels of the energy trading security check time data in the predetermined time period, the first target acquisition error in the predetermined time period and the second target acquisition error in the predetermined time period are substituted into a first target information loss value calculation formula, and the first target information loss value is calculated, and the first target information loss value calculation formula is:

$${L}_{R} = {\sum }_{i = 1}^{{N}_{\text{?}}} ( {k}_{PW}^{t} {k}_{PI}^{t} {e}_{P}^{t} + {k}_{p W}^{t} {k}_{pI}^{t} {e}_{p}^{t} + {k}_{TW}^{t} {k}_{TI}^{t} E [ {{∨}^{9}}_{i = 1} {T}_{Si}^{t} ] ) ;$$

$$\text{?} \text{indicates text missing or illegible when filed}$$

and, L_{R} is the first target information loss value, k_{PW}^{t} is an influence coefficient or weight coefficient of the first target acquisition error, k_{Pl}^{t} is a unit loss value brought about by the first target acquisition error, k_{pW}^{t} is an influence coefficient or weight coefficient of the second target acquisition error, kₚₗ^{t} is a unit loss value brought about by the second target acquisition error, k_{TW}^{t} is an influence coefficient or weight coefficient of the energy trading security check time data, and k_{Tl}^{t} is a unit loss value brought about by the energy trading security check time data;
the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period are substituted into a second target information loss value calculation formula, and the second target information loss value is calculated, and the second target information loss value calculation formula is:

$${L}_{RP} = {L}_{RPH} + {L}_{RPT} + {L}_{RPN} + {L}_{RPG} ;$$

$${L}_{RPH} = {\sum }_{i = 1}^{{N}_{\text{?}}} {k}_{PW}^{t} {k}_{PI}^{t} E [ {e}_{RP}^{t} ] \cdot E [ {e}_{RPH}^{t} ] ;$$

$${L}_{RPT} = {\sum }_{i = 1}^{{N}_{\text{?}}} {k}_{PW}^{t} {k}_{PI}^{t} E [ {e}_{RP}^{t} ] \cdot E [ {e}_{RPG}^{t} ] ;$$

$${L}_{RPN} = {\sum }_{i = 1}^{{N}_{\text{?}}} {k}_{PW}^{t} {k}_{PI}^{t} E [ {e}_{RP}^{t} ] \cdot E [ {e}_{RPN}^{t} ] ;$$

$${L}_{RPG} = {\sum }_{i = 1}^{{N}_{\text{?}}} {k}_{PW}^{t} {k}_{PI}^{t} E [ {e}_{RP}^{t} ] \cdot E [ {e}_{RPG}^{t} ] ;$$

$$\text{?} \text{indicates text missing or illegible when filed}$$

the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period are substituted into a third target information loss value calculation formula, and the third target information loss value is calculated, and the third target information loss value calculation formula is:

$${L}_{Rp} = {L}_{RpH} + {L}_{RpT} + {L}_{RpN} + {L}_{RpG} ;$$

$${L}_{RpH} = {\sum }_{i = 1}^{{N}_{\text{?}}} {k}_{p W}^{t} {k}_{pI}^{t} E [ {e}_{Rp}^{t} ] \cdot E [ {e}_{RpH}^{t} ] ;$$

$${L}_{RpT} = {\sum }_{i = 1}^{{N}_{\text{?}}} {k}_{p W}^{t} {k}_{pI}^{t} E [ {e}_{Rp}^{t} ] \cdot E [ {e}_{RpG}^{t} ] ;$$

$${L}_{RpN} = {\sum }_{i = 1}^{{N}_{\text{?}}} {k}_{p W}^{t} {k}_{pI}^{t} E [ {e}_{Rp}^{t} ] \cdot E [ {e}_{RpN}^{t} ] ;$$

$${L}_{RpG} = {\sum }_{i = 1}^{{N}_{\text{?}}} {k}_{p W}^{t} {k}_{pI}^{t} E [ {e}_{Rp}^{t} ] \cdot E [ {e}_{RpG}^{t} ] .$$

$$\text{?} \text{indicates text missing or illegible when filed}$$

In in optional implementation, according to the target information benefit value, the first target information loss value, the second target information loss value and the third target information loss value, the trust metric of the power Internet of Things to the predetermined unit is calculated, and the access control of the predetermined unit is performed according to the trust metric includes:
the target information benefit value, the first target information loss value, the second target information loss value and the third target information loss value are substituted into a trust metric calculation formula, and the trust metric is calculated;
and the trust metric calculation formula is:

$${B}_{\text{?}} = \frac{{R}_{RP}}{{R}_{RP} + \frac{{L}_{R} + {L}_{RP} + {L}_{Rp}}{2}} ;$$

$$\text{?} \text{indicates text missing or illegible when filed}$$

and B_{I} is the trust metric, R_{RP} is the target information benefit value, L_{R} is the first target information loss value, L_{RP} is the second target information loss value, and L_{Rp} is the third target information loss value;
in the case where the trust metric is greater than or equal to a first threshold value and less than a second threshold value, the predetermined unit is allowed to access the power Internet of Things at any time point;
in a case where the trust metric is less than the first threshold and greater than or equal to a third threshold, the predetermined unit is allowed to access the power Internet of Things at a pre-set number of time points;
and in a case where the trust metric is less than the third threshold value and greater than a fourth threshold value, the predetermined unit is prohibited from accessing the power Internet of Things.

Specifically, when B satisfies: 0.5≤B_{I}<1 time, the predetermined unit is allowed to access the power Internet of things at any time point.

When B satisfies: 0.3≤B₁<0.5, the predetermined unit is allowed to access the power Internet of things at a pre-set number of time points.

When B satisfies: 0≤B_{I}<0.3, the predetermined unit is prohibited from accessing the power Internet of Things.

It should be noted that, the steps shown in the flowchart of the drawings can be executed in a computer system such as a set of computer executable instructions, and although the logic order is shown in the flowchart, in some cases, the shown or described steps can be executed in an order different from that described here.

An embodiment of the present application also provides an apparatus for controlling access to power Internet of Things. It should be noted that the apparatus for controlling access to the power Internet of Things of the embodiment of the present application can be used for executing the method for controlling access to the power Internet of Things provided by the embodiment of the present application. The apparatus is configured to implement the described embodiment and example implementation mode, and what has been described will not be elaborated. The term “component”, as used hereinafter, is a combination of software and/or hardware capable of realizing a predetermined function.

Although the apparatus described in the following embodiment is preferably implemented by software, implementation of hardware or a combination of software and hardware is also possible and conceived.

An apparatus for controlling access to power Internet of Things according to an embodiment of the present application will be introduced below.

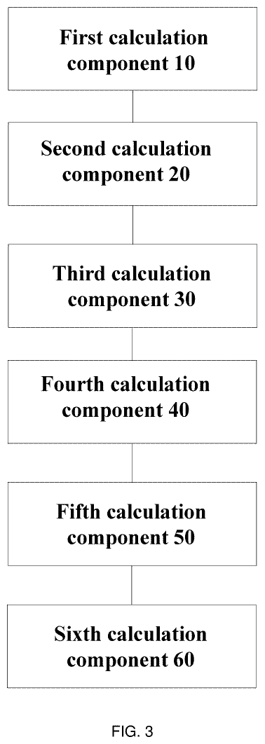

FIG. 3 is a schematic diagram of an apparatus for controlling access to power Internet of Things according to an embodiment of the present disclosure. As shown in FIG. 3, the apparatus includes:
a first calculation component 10, configured to calculate, according to power/power amount trading response quantity data of a predetermined unit, a two-dimensional trapezoidal fuzzy set of acquisition errors of the power/power amount trading response quantity data of the predetermined unit in a predetermined time period by a statistical analysis method, calculate, according to offer data of the predetermined unit, a two-dimensional trapezoidal fuzzy set of acquisition errors of the offer data of the predetermined unit in the predetermined time period by the statistical analysis method, calculate, according to transaction price data of an energy market, a two-dimensional trapezoidal fuzzy set of acquisition errors of the transaction price data of the energy market in the predetermined time period by the statistical analysis method, calculate, according to power/power amount demand quantity data of a power market, a two-dimensional trapezoidal fuzzy set of acquisition errors of the power/power amount demand quantity data of the power market in the predetermined time period by the statistical analysis method, calculate, according to energy trading security check time data, a plurality of two-dimensional trapezoidal fuzzy sets of a plurality of fuzzy uncertainties at different levels of the energy trading security check time data in the predetermined time period by the statistical analysis method;
and the predetermined unit includes a hydro-power unit, a thermal power unit, a nuclear power unit and an air power unit;
a second calculation component 20, configured to calculate, according to data transmission rate data of an Internet of Things monitoring data center, a plurality of two-dimensional trapezoidal fuzzy sets of a plurality of fuzzy uncertainties at different levels of the data transmission rate data by the statistical analysis method, calculate, according to data storage sharing scale data of the Internet of Things monitoring data center, a plurality of two-dimensional trapezoidal fuzzy sets of a plurality of fuzzy uncertainties at different levels of the data storage sharing scale data by the statistical analysis method;
a third calculation component 30, configured to calculate a first target acquisition error in the predetermined time period according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, and calculate a second target acquisition error in the predetermined time period according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period;
and the first target acquisition error is an acquisition error of the power/power amount trading response quantity data of the predetermined unit participating in market competition formed in the power Internet of Things, the second target acquisition error is an acquisition error of the offer data of the predetermined unit participating in the market competition formed in the power Internet of Things;
a fourth calculation component 40 configured to calculate a target information benefit value according to the plurality of two-dimensional trapezoidal fuzzy sets of the plurality of fuzzy uncertainties at different levels of the data transmission rate data, the plurality of two-dimensional trapezoidal fuzzy sets of the plurality of fuzzy uncertainties at different levels of the data storage sharing scale data and an information benefit value formed by the power Internet of Things providing a data acquisition to the predetermined unit in a sensing layer;
and the target information benefit value is an information benefit value obtained by the power Internet of Things providing data acquisition, data transmission, data storage and data sharing to the predetermined unit in a market transaction;
a fifth calculation component 50 configured to calculate a first target information loss value according to the plurality of two-dimensional trapezoidal fuzzy sets of the plurality of fuzzy uncertainties at different levels of the energy trading security check time data in the predetermined time period, the first target acquisition error in the predetermined time period and the second target acquisition error in the predetermined time period; and calculate a second target information loss value according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period; and calculate a third target information loss value according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period;
and the first target information loss value is an information loss value of a market transaction caused by the acquisition errors of the power/power amount transaction response data of the predetermined unit participating in the market competition formed in the power Internet of Things, the acquisition errors of the offer data of the predetermined unit participating in the market competition formed in the power Internet of Things, and the energy trading security check time data in the predetermined time period, the second target information loss value is an information loss value of the market transaction caused by the acquisition errors of the power/power amount trading response quantity data of the predetermined unit participating in the market competition formed in the power Internet of Things in the market transaction, the third target information loss value is an information loss value of the market transaction caused by the acquisition errors of the offer data of the predetermined unit participating in the market competition formed in the power Internet of Things in the market transaction;
a sixth calculation component 60, configured to calculate a trust metric of the power Internet of Things to the predetermined unit according to the target information benefit value, the first target information loss value, the second target information loss value and the third target information loss value, and perform access control of the predetermined unit according to the trust metric.

The above-mentioned apparatus for controlling access to the power Internet of Things includes a processor and a memory, and the described first calculation component, the second calculation component, the third calculation component, the fourth calculation component, the fifth calculation component and the sixth calculation component, etc. are all stored in the memory as program components, and the processor executes the described program components stored in the memory to realize corresponding functions. All the described components are located in the same processor; alternatively, the components are located in different processors in an arbitrary combination.

The processor includes a kernel, and the kernel calls a corresponding program unit from a memory. One or more cores may be provided, and a core parameter is adjusted to at least solve the problem in the prior art that the control effect of a unit accessing a power Internet of Things is poor because a benefit value and a loss value are not considered in the calculation of the trust metric of the power Internet of Things to an access unit.

The memory may include a non-permanent memory in a computer readable medium, a random access memory (RAM), and/or a non-volatile memory, such as a read-only memory (ROM) or a flash RAM, and the memory includes at least one memory chip.

Embodiments of the present invention provide a non-transitory computer readable storage medium. The non-transitory computer readable storage medium includes a stored program. The program, when running, controls a device in which the non-transitory computer readable storage medium is located to execute the method for controlling access to the power Internet of Things.

Provided is a processor. The processor is used for running a program. The program executes the method for controlling access to the power Internet of Things during running.

The present application further provides a computer program product, which, when being executed on a data processing device, is suitable for executing a program for initializing at least the following method steps:
step S201, a two-dimensional trapezoidal fuzzy set of acquisition errors of the power/power amount trading response quantity data of the predetermined unit in a predetermined time period is calculated by a statistical analysis method according to power/power amount trading response quantity data of a predetermined unit, a two-dimensional trapezoidal fuzzy set of acquisition errors of the offer data of the predetermined unit in the predetermined time period is calculated by the statistical analysis method according to offer data of the predetermined unit, a two-dimensional trapezoidal fuzzy set of acquisition errors of the transaction price data of the energy market in the predetermined time period is calculated by the statistical analysis method according to transaction price data of an energy market, a two-dimensional trapezoidal fuzzy set of acquisition errors of the power/power amount demand quantity data of the power market in the predetermined time period is calculated by the statistical analysis method according to power/power amount demand quantity data of a power market, a plurality of two-dimensional trapezoidal fuzzy sets of a plurality of fuzzy uncertainties at different levels of the energy trading security check time data in the predetermined time period are calculated by the statistical analysis method according to energy trading security check time data;
and, the predetermined unit includes a hydro-power unit, a thermal power unit, a nuclear power unit and an air power unit;
step S202, a plurality of two-dimensional trapezoidal fuzzy sets of a plurality of fuzzy uncertainties at different levels of the data transmission rate data are calculated by the statistical analysis method according to data transmission rate data of an Internet of Things monitoring data center, a plurality of two-dimensional trapezoidal fuzzy sets of a plurality of fuzzy uncertainties at different levels of the data storage sharing scale data are calculated by the statistical analysis method according to data storage sharing scale data of the Internet of Things monitoring data center;
step S203, a first target acquisition error in the predetermined time period is calculated according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, and a second target acquisition error in the predetermined time period is calculated according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period;
and the first target acquisition error is an acquisition error of the power/power amount trading response quantity data of the predetermined unit participating in market competition formed in the power Internet of Things, the second target acquisition error is an acquisition error of the offer data of the predetermined unit participating in the market competition formed in the power Internet of Things;
Step S204, a target information benefit value is calculated according to the plurality of two-dimensional trapezoidal fuzzy sets of the plurality of fuzzy uncertainties at different levels of the data transmission rate data, the plurality of two-dimensional trapezoidal fuzzy sets of the plurality of fuzzy uncertainties at different levels of the data storage sharing scale data and an information benefit value formed by the power Internet of Things providing a data acquisition to the predetermined unit in a sensing layer;
and the target information benefit value is an information benefit value obtained by the power Internet of Things providing data acquisition, data transmission, data storage and data sharing to the predetermined unit in a market transaction;
step S205, a first target information loss value is calculated according to the plurality of two-dimensional trapezoidal fuzzy sets of the plurality of fuzzy uncertainties at different levels of the energy trading security check time data in the predetermined time period, the first target acquisition error in the predetermined time period and the second target acquisition error in the predetermined time period; and a second target information loss value is calculated according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period; and a third target information loss value is calculated according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period;
and the first target information loss value is an information loss value of a market transaction caused by the acquisition errors of the power/power amount transaction response data of the predetermined unit participating in the market competition formed in the power Internet of Things, the acquisition errors of the offer data of the predetermined unit participating in the market competition formed in the power Internet of Things, and the energy trading security check time data in the predetermined time period, the second target information loss value is an information loss value of the market transaction caused by the acquisition errors of the power/power amount trading response quantity data of the predetermined unit participating in the market competition formed in the power Internet of Things in the market transaction, the third target information loss value is an information loss value of the market transaction caused by the acquisition errors of the offer data of the predetermined unit participating in the market competition formed in the power Internet of Things in the market transaction;
step S206: a trust metric of the power Internet of Things to the predetermined unit is calculated according to the target information benefit value, the first target information loss value, the second target information loss value and the third target information loss value, and access control of the predetermined unit is performed according to the trust metric.

Obviously, those skilled in the art should understand that each component or each step of the present invention can be implemented by a universal computing device, and the components or steps can be concentrated on a single computing device or distributed on a network formed by a plurality of computing devices, and can be implemented by program codes executable for the computing devices, so that the components or steps can be stored in a storage device for execution with the computing devices, the shown or described steps can be executed in sequences different from those described here in some cases, or the components or steps can be made into integrated circuit components respectively, or multiple components or steps therein can be made into a single integrated circuit component for implementation. Thus, the present invention is not limited to any specific combination of hardware and software.

Those skilled in the art shall understand that the embodiments of the present application can be provided as a method, a system or a computer program product. Therefore, the present disclosure may take the form of an entirely hardware embodiment, an entirely software embodiment or an embodiment combining software and hardware. Furthermore, the present application may take the form of a computer program product implemented on one or more computer-usable storage media (including but not limited to a disk memory, a CD-ROM, an optical memory, etc.) containing computer-usable program codes.

The present application is described with reference to the flowcharts and/or block diagrams of the method, device (system), and computer program product according to the embodiments of the present application. It should be understood that each flow and/or block in the flowcharts and/or block diagrams and combinations of flows and/or blocks in the flowcharts and/or block diagrams can be implemented by computer program instructions. These computer program instructions may be provided to a general-purpose computer, a dedicated computer, an embedded processor, or a processor of another programmable data processing device to generate a machine, so that an apparatus for implementing functions specified in one or more flows in the flowchart and/or one or more blocks in the block diagram is generated through instructions executed by the computer or the processor of another programmable data processing device.

These computer program instructions may also be stored in a computer-readable memory capable of guiding a computer or other programmable data processing apparatuses to work in a specific manner, so that the instructions stored in the computer-readable memory generate a manufactured product including an instruction apparatus, and the instruction apparatus implements functions specified in one or more flows in the flowchart and/or one or more blocks in the block diagram.

These computer program instructions may also be loaded onto a computer or another programmable data processing device, so that a series of operation steps are executed on the computer or the other programmable data processing device to generate processing implemented by the computer, so that the instructions executed on the computer or the other programmable data processing device provide steps for implementing functions specified in one or more flows in the flowchart and/or one or more blocks in the block diagram.

In a typical configuration, the computing device includes one or more processors (CPUs), an input/output interface, a network interface, and memory.

The memory may include a non-permanent storage in a computer readable medium, a random access memory (RAM), and/or a non-volatile memory, such as a read-only memory (ROM) or a flash RAM. A memory is an example of a computer-readable medium.

Computer-readable media, including both persistent and non-persistent, removable and non-removable media, may implement information storage by any method or technology. The information may be computer readable instructions, data structures, components of a program, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disc (DVD) or other optical storage, magnetic cassettes, magnetic disk storage or other magnetic storage devices, or any other non-transmission media, which can be used to store information that can be accessed by a computing device. As defined herein, computer-readable media does not include transitory computer-readable media, such as modulated data signals and carrier waves.

It should also be noted that the terms “include”, “including”, or any other variation thereof are intended to cover a non-exclusive inclusion, so that a process, a method, a commodity, or a device that includes a series of elements not only includes those elements, but also includes other elements that are not explicitly listed, or further includes inherent elements of the process, the method, the commodity, or the device. Without further limitation, an element limited by “include a . . . ” does not exclude other same elements existing in a process, a method, a commodity, or a device that includes the element.

The foregoing descriptions are merely exemplary embodiments of the present application, but are not intended to limit the present application. For those skilled in the art, the present application may have various modifications and variations. Any modifications, equivalent replacements, improvements and the like made within the spirit and principle of the present application shall belong to the scope of protection of the present application.

What is claimed is:

1. A method for controlling access to power Internet of Things, comprising:
calculating, according to power/power amount trading response quantity data of a predetermined unit, a two-dimensional trapezoidal fuzzy set of acquisition errors of the power/power amount trading response quantity data of the predetermined unit in a predetermined time period by a statistical analysis method, calculating, according to offer data of the predetermined unit, a two-dimensional trapezoidal fuzzy set of acquisition errors of the offer data of the predetermined unit in the predetermined time period by the statistical analysis method, calculating, according to transaction price data of an energy market, a two-dimensional trapezoidal fuzzy set of acquisition errors of the transaction price data of the energy market in the predetermined time period by the statistical analysis method, calculating, according to power/power amount demand quantity data of a power market, a two-dimensional trapezoidal fuzzy set of acquisition errors of the power/power amount demand quantity data of the power market in the predetermined time period by the statistical analysis method, calculating, according to energy trading security check time data, a plurality of two-dimensional trapezoidal fuzzy sets of a plurality of fuzzy uncertainties at different levels of the energy trading security check time data in the predetermined time period by the statistical analysis method, wherein the predetermined unit comprises a hydro-power unit, a thermal power unit, a nuclear power unit and an air power unit;
calculating, according to data transmission rate data of an Internet of Things monitoring data center, a plurality of two-dimensional trapezoidal fuzzy sets of a plurality of fuzzy uncertainties at different levels of the data transmission rate data by the statistical analysis method, calculating, according to data storage sharing scale data of the Internet of Things monitoring data center, a plurality of two-dimensional trapezoidal fuzzy sets of a plurality of fuzzy uncertainties at different levels of the data storage sharing scale data by the statistical analysis method;
according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, calculating a first target acquisition error in the predetermined time period, and according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, calculating a second target acquisition error in the predetermined time period, wherein the first target acquisition error is an acquisition error of the power/power amount trading response quantity data of the predetermined unit participating in market competition formed in the power Internet of Things, the second target acquisition error is an acquisition error of the offer data of the predetermined unit participating in the market competition formed in the power Internet of Things;
according to the plurality of two-dimensional trapezoidal fuzzy sets of the plurality of fuzzy uncertainties at different levels of the data transmission rate data, the plurality of two-dimensional trapezoidal fuzzy sets of the plurality of fuzzy uncertainties at different levels of the data storage sharing scale data and an information benefit value formed by the power Internet of Things providing a data acquisition to the predetermined unit in a sensing layer, calculating a target information benefit value, wherein the target information benefit value is an information benefit value obtained by the power Internet of Things providing data acquisition, data transmission, data storage and data sharing to the predetermined unit in a market transaction;
according to the plurality of two-dimensional trapezoidal fuzzy sets of the plurality of fuzzy uncertainties at different levels of the energy trading security check time data in the predetermined time period, the first target acquisition error in the predetermined time period and the second target acquisition error in the predetermined time period, calculating a first target information loss value; and according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, calculating a second target information loss value; and according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, calculating a third target information loss value, wherein the first target information loss value is an information loss value of a market transaction caused by the acquisition errors of the power/power amount transaction response data of the predetermined unit participating in the market competition formed in the power Internet of Things, the acquisition errors of the offer data of the predetermined unit participating in the market competition formed in the power Internet of Things, and the energy trading security check time data in the predetermined time period, the second target information loss value is an information loss value of the market transaction caused by the acquisition errors of the power/power amount trading response quantity data of the predetermined unit participating in the market competition formed in the power Internet of Things in the market transaction, the third target information loss value is an information loss value of the market transaction caused by the acquisition errors of the offer data of the predetermined unit participating in the market competition formed in the power Internet of Things in the market transaction;
according to the target information benefit value, the first target information loss value, the second target information loss value and the third target information loss value, calculating a trust metric of the power Internet of Things to the predetermined unit, and performing access control of the predetermined unit according to the trust metric.

2. The method as claimed in claim 1, wherein the two-dimensional trapezoidal fuzzy set of the acquisition errors of the power/power amount trading response quantity data of the predetermined unit in the predetermined time period is:
$$\begin{matrix}{e}_{RPH}^{t} = ( {e}_{RPHL}^{t} , {e}_{RPHU}^{t} ) = [ ( {e}_{RPHL 1}^{t} , {e}_{RPHL 2}^{t} , {e}_{RPHL 3}^{t} , {e}_{RPHL 4}^{t} ; {k}_{eRPHL}^{t} ) , \\ ( {e}_{RPHU 1}^{t} , {e}_{RPHU 2}^{t} , {e}_{RPHU 3}^{t} , {e}_{RPHU 4}^{t} ; {k}_{eRPHU}^{t} ) ]\end{matrix} ;$$
$$\begin{matrix}{e}_{RPT}^{t} = ( {e}_{RPTL}^{t} , {e}_{RPTU}^{t} ) = [ ( {e}_{RPTL 1}^{t} , {e}_{RPTL 2}^{t} , {e}_{RPTL 3}^{t} , {e}_{RPTL 4}^{t} ; {k}_{eRPTL}^{t} ) , \\ ( {e}_{RPTU 1}^{t} , {e}_{RPTU 2}^{t} , {e}_{RPTU 3}^{t} , {e}_{RPTU 4}^{t} ; {k}_{eRPTU}^{t} ) ]\end{matrix} ;$$
$$\begin{matrix}{e}_{RPN}^{t} = ( {e}_{RPNL}^{t} , {e}_{RPNU}^{t} ) = [ ( {e}_{RPNL 1}^{t} , {e}_{RPNL 2}^{t} , {e}_{RPNL 3}^{t} , {e}_{RPNL 4}^{t} ; {k}_{eRPNL}^{t} ) , \\ ( {e}_{RPNU 1}^{t} , {e}_{RPNU 2}^{t} , {e}_{RPNU 3}^{t} , {e}_{RPNU 4}^{t} ; {k}_{eRPNU}^{t} ) ]\end{matrix} ;$$
$$\begin{matrix}{e}_{RPG}^{t} = ( {e}_{RPGL}^{t} , {e}_{RPGU}^{t} ) = [ ( {e}_{RPGL 1}^{t} , {e}_{RPGL 2}^{t} , {e}_{RPGL 3}^{t} , {e}_{RPGL 4}^{t} ; {k}_{eRPGL}^{t} ) , \\ ( {e}_{RPGU 1}^{t} , {e}_{RPGU 2}^{t} , {e}_{RPGU 3}^{t} , {e}_{RPGU 4}^{t} ; {k}_{eRPGU}^{t} ) ]\end{matrix} ;$$
wherein t is the predetermined time period, e_{RPH}^{t} is the two-dimensional trapezoidal fuzzy set of the acquisition errors of the power/power amount trading response quantity data of the hydro-power unit in the predetermined time period, e_{RPHLj}^{t} is a fuzzy number corresponding to a lower bound of a two-dimensional trapezoidal fuzzy set of acquisition errors of the power/power amount trading response quantity data of the hydro-power unit in the predetermined period, k_{eRPHL}^{t} a membership coefficient of a fuzzy number corresponding to the lower bound of the two-dimensional trapezoidal fuzzy set of the acquisition errors of the power/power amount trading response quantity data of the hydro-power unit in the predetermined period, e_{RPHUj}^{t} is a fuzzy number corresponding to an upper bound of the two-dimensional trapezoidal fuzzy set of the acquisition errors of the power/power amount trading response quantity data of the hydro-power unit in the predetermined period, k_{eRPHU}^{t} is a membership coefficient of the fuzzy number corresponding to the upper bound of the two-dimensional trapezoidal fuzzy set of the acquisition errors of the power/power amount trading response quantity data of the hydro-power unit in the predetermined period, e_{RPT}^{t} is the two-dimensional trapezoidal fuzzy set of the acquisition errors of the power/power amount trading response quantity data of the thermal power unit in the predetermined time period, e_{RPTLj}^{t} is a fuzzy number corresponding to a lower bound of the two-dimensional trapezoidal fuzzy set of the acquisition errors of the power/power amount trading response quantity data of the thermal power unit in the predetermined time period, k_{eRPTL}^{t} is a membership coefficient of the fuzzy number corresponding to the lower bound of the two-dimensional trapezoidal fuzzy set of the acquisition errors of the power/power amount trading response quantity data of the thermal power unit in the predetermined period, e_{RPTUj}^{t} is a fuzzy number corresponding to an upper bound of the two-dimensional trapezoidal fuzzy set of the acquisition errors of the power/power amount trading response quantity data of the thermal power unit in the predetermined time period, k_{eRPTU}^{t} is a membership coefficient of the fuzzy number corresponding to the upper bound of the two-dimensional trapezoidal fuzzy set of the acquisition errors of the power/power amount trading response quantity data of the thermal power unit in the predetermined period, e_{RPN}^{t} is the two-dimensional trapezoidal fuzzy set of the acquisition errors of the power/power amount trading response quantity data of the nuclear power unit in the predetermined time period, e_{RPNLj}^{t} is a fuzzy number corresponding to a lower bound of the two-dimensional trapezoidal fuzzy set of the acquisition errors of the power/power amount trading response quantity data of the nuclear power unit in the predetermined period, k_{eRPNL}^{t} is a membership coefficient of the fuzzy number corresponding to the lower bound of the two-dimensional trapezoidal ambiguous set of acquisition errors of the power/power amount trading response quantity data of the nuclear power unit in the predetermined time period, e_{RPNUj}^{t} is a fuzzy number corresponding to an upper bound of the two-dimensional trapezoidal fuzzy set of the acquisition errors of the power/power amount trading response quantity data of the nuclear power unit in the predetermined period, k_{eRPNUj}^{t} is a membership coefficient of the fuzzy number corresponding to the upper bound of the two-dimensional trapezoidal fuzzy set of the acquisition errors of the power/power amount trading response quantity data of the nuclear power unit in the predetermined time period, e_{PRG}^{t}, is the two-dimensional trapezoidal fuzzy set of the acquisition errors of the power/power amount trading response quantity data of the air power unit in the predetermined time period, e_{RPGLj}^{t} is a fuzzy number corresponding to a lower bound of the two-dimensional trapezoidal fuzzy set of the acquisition errors of the power/power amount trading response quantity data of the air power unit in the predetermined time period, k_{eRPGL}^{t} is a membership coefficient of the fuzzy number corresponding to the lower bound of the two-dimensional trapezoidal fuzzy set of the acquisition errors of the power/power amount trading response quantity data of the air power unit in the predetermined time period, e_{RPGUj}^{t} is a fuzzy number corresponding to an upper bound of the two-dimensional trapezoidal fuzzy set of the acquisition errors of the power/power amount trading response quantity data of the air power unit in the predetermined time period, k_{eRPGU}^{t} is a membership coefficient of the fuzzy number corresponding to the upper bound of the two-dimensional trapezoidal fuzzy set of the acquisition errors of the power/power amount trading response quantity data of the air power unit in the predetermined time period, t=1, 2, . . . , N_{RP}, j=1, 2, 3, 4;
the two-dimensional trapezoidal fuzzy set of the acquisition errors of the offer data of the predetermined unit in the predetermined time period is:
$$\begin{matrix}{e}_{RpH}^{t} = ( {e}_{RpHL}^{t} , {e}_{RpHU}^{t} ) = [ ( {e}_{RpHL 1}^{t} , {e}_{RpHL 2}^{t} , {e}_{RpHL 3}^{t} , {e}_{RpHL 4}^{t} ; {k}_{eRpHL}^{t} ) , \\ ( {e}_{RpHU 1}^{t} , {e}_{RpHU 2}^{t} , {e}_{RpHU 3}^{t} , {e}_{RpHU 4}^{t} ; {k}_{eRpHU}^{t} ) ]\end{matrix} ;$$
$$\begin{matrix}{e}_{RpT}^{t} = ( {e}_{RpTL}^{t} , {e}_{RpTU}^{t} ) = [ ( {e}_{RpTL 1}^{t} , {e}_{RpTL 2}^{t} , {e}_{RpTL 3}^{t} , {e}_{RpTL 4}^{t} ; {k}_{eRpTL}^{t} ) , \\ ( {e}_{RpTU 1}^{t} , {e}_{RpTU 2}^{t} , {e}_{RpTU 3}^{t} , {e}_{RpTU 4}^{t} ; {k}_{eRpTU}^{t} ) ]\end{matrix} ;$$
$$\begin{matrix}{e}_{RpN}^{t} = ( {e}_{RpNL}^{t} , {e}_{RpNU}^{t} ) = [ ( {e}_{RpNL 1}^{t} , {e}_{RpNL 2}^{t} , {e}_{RpNL 3}^{t} , {e}_{RpNL 4}^{t} ; {k}_{eRpNL}^{t} ) , \\ ( {e}_{RpNU 1}^{t} , {e}_{RpNU 2}^{t} , {e}_{RpNU 3}^{t} , {e}_{RpNU 4}^{t} ; {k}_{eRpNU}^{t} ) ]\end{matrix} ;$$
$$\begin{matrix}{e}_{RpG}^{t} = ( {e}_{RpGL}^{t} , {e}_{RpGU}^{t} ) = [ ( {e}_{RpGL 1}^{t} , {e}_{RpGL 2}^{t} , {e}_{RpGL 3}^{t} , {e}_{RpGL 4}^{t} ; {k}_{eRpGL}^{t} ) , \\ ( {e}_{RpGU 1}^{t} , {e}_{RpGU 2}^{t} , {e}_{RpGU 3}^{t} , {e}_{RpGU 4}^{t} ; {k}_{eRpGU}^{t} ) ]\end{matrix} ;$$
wherein e_{RpH}^{t} is the two-dimensional trapezoidal fuzzy set of the acquisition errors of the offer data of the hydro-power unit in the predetermined time period, e_{RpHLj}^{t} is a fuzzy number corresponding to a lower bound of the two dimensional trapezoidal fuzzy set of the acquisition errors of the offer data of the hydro power unit in the predetermined period, k_{eRpBL}^{t} is a membership coefficient of the fuzzy number acquisition errors of the offer data of the the two-dimensional trapezoidal fuzzy set of the acquisition errors of the offer data of the hydro-power unit in the predetermined time period, e_{RpHUj}^{t} is a fuzzy number corresponding to an upper bound of the two-dimensional trapezoidal fuzzy set of the acquisition errors of the offer data of the hydro-power unit in the predetermined period, k_{eRpHU}^{t} is a membership coefficient of the fuzzy number corresponding to the upper bound of the two-dimensional trapezoidal fuzzy set of the acquisition errors of the offer data of the hydro-power unit in the predetermined period, e_{RpT}^{t} is the two-dimensional trapezoidal fuzzy set of the acquisition errors of the offer data of the thermal power unit in the predetermined time period, e_{RpTLj}^{t} is a fuzzy number corresponding to a lower bound of the two-dimensional trapezoidal fuzzy set of the acquisition errors of the offer data of the thermal power unit in the predetermined time period, k_{eRpTL}^{t} is a membership coefficient of the fuzzy number corresponding to the lower bound of the two-dimensional trapezoidal fuzzy set of the acquisition errors of the offer data of the thermal power unit in the predetermined time period, e_{RpTUj}^{t} is a fuzzy number corresponding to an upper bound of the two-dimensional trapezoidal fuzzy set of the acquisition errors of the offer data of the thermal power unit in the predetermined time period, k_{eRpTU}^{t} is a membership coefficient of the fuzzy number corresponding to the upper bound of the two-dimensional trapezoidal fuzzy set of the acquisition errors of the offer data of the thermal power unit in the predetermined time period, e_{RpN}^{t} is the two-dimensional trapezoidal fuzzy set of the acquisition errors of the offer data of the nuclear power unit in the predetermined time period, e_{RpNLj}^{t} is a fuzzy number corresponding to a lower bound of the two-dimensional trapezoidal fuzzy set of the acquisition errors of the offer data of the nuclear power unit in the predetermined time period, k_{eRpNL}^{t} is a membership coefficient of the fuzzy number corresponding to the lower bound of the two-dimensional trapezoidal fuzzy set of the acquisition errors of the offer data of the nuclear power unit in the predetermined time period, e_{RpNUj}^{t} is a fuzzy number corresponding to an upper bound of the two-dimensional trapezoidal fuzzy set of the acquisition errors of the offer data of the nuclear power unit in the predetermined time period, k_{eRPU}^{t} is a membership coefficient of the fuzzy number corresponding to the upper bound of the two-dimensional trapezoidal fuzzy set of the acquisition errors of the offer data of the nuclear power unit in the predetermined period, e_{RpG}^{t} is the two-dimensional trapezoidal fuzzy set of the acquisition errors of the offer data of the air power unit in the predetermined time period, e_{RpGLj}^{t} is a fuzzy number corresponding to a lower bound of the two-dimensional trapezoidal fuzzy set of the acquisition errors of the offer data of the air power unit in the predetermined time period, k_{eRpGL}^{t} is a membership coefficient of the fuzzy number corresponding to the lower bound of the two-dimensional trapezoidal fuzzy set of the acquisition error of the offer data of the air power unit in the predetermined time period, e_{RpGUj}^{t} is a fuzzy number corresponding to an upper bound of the two-dimensional trapezoidal fuzzy set of the acquisition errors of the offer data of the air power unit in the predetermined time period, k_{eRpGU}^{t} is a membership coefficient of the fuzzy number corresponding to the upper bound of the two-dimensional trapezoidal fuzzy set of the acquisition errors of the offer data of the air power unit in the predetermined time period;
the two-dimensional trapezoidal fuzzy set of the acquisition errors of the transaction price data of the energy market in the predetermined time period is:
$${e}_{Rp}^{t} = ( {e}_{RpL}^{t} , {e}_{RpU}^{t} ) = [ ( {e}_{RpL 1}^{t} , {e}_{RpL 2}^{t} , {e}_{RpL 3}^{t} , {e}_{RpL 4}^{t} ; {k}_{eRpL}^{t} ) , ( {e}_{RpU 1}^{t} , {e}_{RpU 2}^{t} , {e}_{RpU 3}^{t} , {e}_{RpU 4}^{t} ; {k}_{eRpU}^{t} ) ] ;$$
wherein e_{Rp}^{t} is the two-dimensional trapezoidal fuzzy set of the acquisition errors of the transaction price data of the energy market in the predetermined time period, e_{RpUj}^{t} is a fuzzy number corresponding to a lower bound of the two-dimensional trapezoidal fuzzy set of the acquisition errors of the transaction price data of the energy market in the predetermined time period, k_{eRpL}^{t} is a membership coefficient of the fuzzy number corresponding to the lower bound of the two-dimensional trapezoidal fuzzy set of the acquisition errors of the transaction price data of the energy market in the predetermined time period, e_{RpUj}^{t} is a fuzzy number corresponding to an upper bound of the two-dimensional trapezoidal fuzzy set of the acquisition errors of the transaction price data of the energy market in the predetermined time period, k_{eRpU}^{t} is a membership coefficient of the fuzzy number corresponding to the upper bound of the two-dimensional trapezoidal fuzzy set of the acquisition errors of the transaction price data of the energy market in the predetermined time period;
the two-dimensional trapezoidal fuzzy set of the acquisition errors of the power/power amount demand quantity data of the power market in the predetermined time period is:
$${e}_{RP}^{t} = ( {e}_{RPL}^{t} , {e}_{RPU}^{t} ) = [ ( {e}_{RPL 1}^{t} , {e}_{RPL 2}^{t} , {e}_{RPL 3}^{t} , {e}_{RPL 4}^{t} ; {k}_{eRPL}^{t} ) , ( {e}_{RPU 1}^{t} , {e}_{RPU 2}^{t} , {e}_{RPU 3}^{t} , {e}_{RPU 4}^{t} ; {k}_{eRPU}^{t} ) ] ;$$
wherein e_{RP}^{t} is the two-dimensional trapezoidal fuzzy set of the acquisition errors of the power/power amount demand quantity data of the power market in the predetermined period, e_{RPLj}^{t} is a fuzzy number corresponding to a lower bound of the two-dimensional trapezoidal fuzzy set of the acquisition errors of the power/power amount demand quantity data of the power market in the predetermined period, k_{eRPL}^{t} is a membership coefficient of the fuzzy number corresponding to the lower bound of the two-dimensional trapezoidal fuzzy set of the acquisition errors of the power/power amount demand quantity data of the power market in the predetermined time period, e_{RPUj}^{t} is a fuzzy number corresponding to an upper bound of the two-dimensional trapezoidal fuzzy set of the acquisition errors of the power/power amount demand quantity data of the power market in the predetermined period, k_{eRPU}^{t} is a membership coefficient of the fuzzy number corresponding to the upper bound of the two-dimensional trapezoidal fuzzy set of the acquisition errors of the power/power amount demand quantity data of the power market in the predetermined time period;
the plurality of two-dimensional trapezoidal fuzzy sets of the plurality of fuzzy uncertainties at different levels of the energy trading security check time data in the predetermined time period is:
$$\text{?} = ( \text{?} ) = [ ( \text{?} ; \text{?} ) , ( \text{?} ; \text{?} ) ] ;$$
$$\text{?} \text{indicates text missing or illegible when filed}$$
wherein, Tₛₗ is a ith two-dimensional trapezoidal fuzzy set of the energy trading security check time data, and T_{SIL} is a fuzzy number corresponding to a lower bound of the two-dimensional trapezoidal fuzzy set of a ith fuzzy uncertainty of the energy trading security check time data, k_{TSiL} is a membership coefficient of the fuzzy number corresponding to the lower bound of the two-dimensional trapezoidal fuzzy set of the ith fuzzy uncertainty of the energy trading security check time data, T_{SiO} is a fuzzy number corresponding to an upper bound of the two-dimensional trapezoidal fuzzy set of the ith fuzzy uncertainty of the energy trading security check time data, k_{TSiU} is a membership coefficient of the fuzzy number corresponding to the upper bound of the two-dimensional trapezoidal fuzzy set of the ith fuzzy uncertainty of the energy trading security check time data.

3. The method as claimed in claim 1, wherein calculating, according to the data transmission rate data of the Internet of Things monitoring data center, the plurality of two-dimensional trapezoidal fuzzy sets of the plurality of fuzzy uncertainties at different levels of the data transmission rate data by the statistical analysis method, calculating, according to the data storage sharing scale data of the Internet of Things monitoring data center, the plurality of two-dimensional trapezoidal fuzzy sets of the plurality of fuzzy uncertainties at different levels of the data storage sharing scale data by the statistical analysis method comprises:
according to the data transmission rate data of the Internet of Things monitoring data center, respectively calculating the plurality of two-dimensional trapezoidal fuzzy sets of nine fuzzy uncertainties of extremely low, very low, low, slightly low, medium, slightly high, high, very high and extremely high of the data transmission rate data by the statistical analysis method:
$$\text{?} = ( \text{?} ) = [ ( \text{?} ; \text{?} ) \text{?} ( \text{?} ; \text{?} ) ] ;$$
$$i = 1 , 2 , … , 9 ;$$
$$\text{?} \text{indicates text missing or illegible when filed}$$
wherein, v_{Di} is a ith two-dimensional trapezoidal fuzzy set of the data transmission rate data, v_{DL} is a fuzzy number corresponding to a lower bound of the two-dimensional trapezoidal fuzzy set of a ith fuzzy uncertainty of the data transmission rate data; k_{DviL} is a membership coefficient of the fuzzy number corresponding to the lower bound of the two-dimensional trapezoidal fuzzy set of the ith fuzzy uncertainty of the data transmission rate data, v_{DiU} is a fuzzy number corresponding to an upper bound of the two-dimensional trapezoidal fuzzy set of the ith fuzzy uncertainty of the data transmission rate data, and k_{DviU} is a membership coefficient of the fuzzy number corresponding to the upper bound of the two-dimensional trapezoidal fuzzy set of the ith fuzzy uncertainty of the data transmission rate data;
according to the data storage sharing scale data of the Internet of Things monitoring data center, respectively calculating the plurality of two-dimensional trapezoidal fuzzy sets of nine fuzzy uncertainties of extremely low, very low, low, slightly low, medium, slightly high, high, very high and extremely high of the data storage sharing scale data by the statistical analysis method:
$$\text{?} = ( \text{?} ) = [ ( \text{?} ; \text{?} ) , ( \text{?} ; \text{?} ) ] ;$$
$$\text{?} \text{indicates text missing or illegible when filed}$$
wherein, S_{Di} is a ith two-dimensional trapezoidal fuzzy set of the data storage sharing scale data, S_{DiL} is a fuzzy number corresponding to a lower bound of the two-dimensional trapezoidal fuzzy set of a ith fuzzy uncertainty of the data storage sharing scale data, k_{DSiL} is a membership coefficient of the fuzzy number corresponding to the lower bound of the two-dimensional trapezoidal fuzzy set of the ith fuzzy uncertainty of the data storage sharing scale data, S_{DiU} is a fuzzy number corresponding to an upper bound of the two-dimensional trapezoidal fuzzy set of the ith fuzzy uncertainty of the data storage sharing scale data, and k_{DSIU} is a membership coefficient of the fuzzy number corresponding to the upper bound of the two-dimensional trapezoidal fuzzy set of the ith fuzzy uncertainty of the data storage sharing scale data.

4. The method as claimed in claim 2, wherein according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, calculating the first target acquisition error in the predetermined time period, and according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, calculating the second target acquisition error in the predetermined time period comprises:
according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, calculating the first target acquisition error in the predetermined time period:
$$\text{?} = E [ \text{?} ⊗ ( \text{?} + \text{?} + \text{?} + \text{?} ) ] ;$$
$$\text{?} \text{indicates text missing or illegible when filed}$$
wherein, E[ ] represents a expected value to be taken in [ ], and ⊗ represents a union of fuzzy sets;
according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, calculating the second target acquisition error in the predetermined time period:
$$\text{?} = E [ \text{?} ⊗ ( \text{?} + \text{?} + \text{?} + \text{?} ) ] .$$
$$\text{?} \text{indicates text missing or illegible when filed}$$

5. The method as claimed in claim 3, wherein according to the plurality of two-dimensional trapezoidal fuzzy sets of the plurality of fuzzy uncertainties at different levels of the data transmission rate data, the plurality of two-dimensional trapezoidal fuzzy sets of the plurality of fuzzy uncertainties at different levels of the data storage sharing scale data and the information benefit value formed by the power Internet of Things providing the data acquisition to the predetermined unit in the sensing layer, calculating the target information benefit value comprises:
substituting the plurality of two-dimensional trapezoidal fuzzy sets of the plurality of fuzzy uncertainties at different levels of the data transmission rate data, the plurality of two-dimensional trapezoidal fuzzy sets of the plurality of fuzzy uncertainties at different levels of the data storage sharing scale data, and the information benefit value formed by the power Internet of Things providing the data acquisition to the predetermined unit in the sensing layer into a target information benefit value calculation formula, and calculating to obtain the target information benefit value;
wherein the target information benefit value calculation formula is:
$${R}_{RP} = E [ \text{?} {k}_{Di} {v}_{Dvi} ⊗ \text{?} {k}_{DSi} \text{?} ⊗ {k}_{Mi} ( \text{?} + \text{?} + {M}_{N} + {M}_{G} ) ] ;$$
$$\text{?} \text{indicates text missing or illegible when filed}$$
R_{RP} is the target information benefit value,
$$\text{?} {k}_{Dvi} {v}_{Dvi}$$
$$\text{?} \text{indicates text missing or illegible when filed}$$
is an information benefit value formed when the power Internet of Things provides the data transmission rate data at nine fuzzy uncertainties rates of extremely low, very low, low, slightly low, medium, slightly high, high, very high and extremely high to the predetermined unit, k_{Dvi} is a unit benefit value brought to the predetermined unit due to the power Internet of Things providing the data transmission rate data at a ith rate,
$$\text{?} {k}_{DSi} {S}_{Di}$$
$$\text{?} \text{indicates text missing or illegible when filed}$$
is an information benefit value formed when the power Internet of Things providing the data storage sharing scale data of nine fuzzy uncertainties scales of extremely low, very low, low, slightly low, medium, slightly high, high, very high and extremely high to the predetermined unit, k_{DSi} is a unit benefit value brought to the predetermined unit due to the power Internet of Things providing the data storage sharing scale data at the ith rate, k_{Mi}M_{H} is an information benefit value formed when the power Internet of Things provides the data acquisition to the hydro-power unit in the sensing layer k_{Mi}M_{T} is an information benefit value formed when the power Internet of Things providing the data acquisition to the thermal power unit in the sensing layer, k_{Mi}M_{N} is an information benefit value formed when the power acquisition layer provides the data acquisition to the nuclear power unit in the sensing layer, k_{Mi}M_{G} is an information benefit value when the power acquisition layer provides the data acquisition to the air power unit in the sensing layer, and k_{Mi} is a unit benefit value brought to the predetermined unit due to the power Internet of Things providing the data acquisition for the predetermined unit in the sensing layer. E[ ] is a expected value to be taken in [ ],
$$\text{?}$$
$$\text{?} \text{indicates text missing or illegible when filed}$$
represents a union of nine fuzzy sets.

6. The method as claimed in claim 4, wherein according to the plurality of two-dimensional trapezoidal fuzzy sets of the plurality of fuzzy uncertainties at different levels of the energy trading security check time data in the predetermined time period, the first target acquisition error in the predetermined time period and the second target acquisition error in the predetermined time period, calculating the first target information loss value; and according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, calculating the second target information loss value; and according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, calculating the third target information loss value comprises:
substituting the plurality of two-dimensional trapezoidal fuzzy sets of the plurality of fuzzy uncertainties at different levels of the energy trading security check time data in the predetermined time period, the first target acquisition error in the predetermined time period and the second target acquisition error in the predetermined time period into a first target information loss value calculation formula, and calculating the first target information loss value, wherein the first target information loss value calculation formula is:
$${L}_{R} = \text{?} ( \text{?} + \text{?} + \text{?} E [ \text{?} ] ) ;$$
$$\text{?} \text{indicates text missing or illegible when filed}$$
L_{R} is the first target information loss value, k_{PW}^{t} is an influence coefficient or weight coefficient of the first target acquisition error, k_{Pl}^{t} is a unit loss value brought about by the first target acquisition error, k_{pW}^{t} is an influence coefficient or weight coefficient of the second target acquisition error, kₚₗ^{t} is a unit loss value brought about by the second target acquisition error, k_{TW}^{t} is an influence coefficient or weight coefficient of the energy trading security check time data, and is a unit loss value brought about by the energy trading security check time data;
substituting the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period into a second target information loss value calculation formula, and calculating the second target information loss value, wherein the second target information loss value calculation formula is:
$${L}_{RP} = \text{?} + \text{?} + {L}_{RPN} + {L}_{RPG} ;$$
$$\text{?} = \text{?} E [ \text{?} ] \text{?} E [ \text{?} ] ;$$
$$\text{?} = \text{?} E [ \text{?} ] \text{?} E [ \text{?} ] ;$$
$${L}_{RPN} = \text{?} E [ \text{?} ] \text{?} E [ \text{?} ] ;$$
$${L}_{RPG} = \text{?} E [ \text{?} ] \text{?} E [ \text{?} ] ;$$
$$\text{?} \text{indicates text missing or illegible when filed}$$
substituting the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period into a third target information loss value calculation formula, and calculating the third target information loss value, wherein the third target information loss value calculation formula is:
$${L}_{Rp} = \text{?} + \text{?} + {L}_{RpN} + \text{?} ;$$
$$\text{?} = \text{?} E [ \text{?} ] \text{?} E [ \text{?} ] ;$$
$$\text{?} = \text{?} E [ \text{?} ] \text{?} E [ \text{?} ] ;$$
$${L}_{RpN} = \text{?} E [ \text{?} ] \text{?} E [ \text{?} ] ;$$
$$\text{?} = \text{?} E [ \text{?} ] \text{?} E [ \text{?} ] .$$
$$\text{?} \text{indicates text missing or illegible when filed}$$

7. The method as claimed in claim 1, wherein according to the target information benefit value, the first target information loss value, the second target information loss value and the third target information loss value, calculating the trust metric of the power Internet of Things to the predetermined unit, and performing the access control of the predetermined unit according to the trust metric comprises:
substituting the target information benefit value, the first target information loss value, the second target information loss value and the third target information loss value into a trust metric calculation formula, and calculating the trust metric;
wherein, the trust metric calculation formula is:
$${B}_{1} = \frac{{R}_{RP}}{{R}_{RP} + \frac{{L}_{R} + {L}_{RP} + {L}_{Rp}}{2}} ;$$
B_{I} is the trust metric, R_{RP} is the target information benefit value, L_{R} is the first target information loss value, L_{RP} is the second target information loss value, and L_{Rp} is the third target information loss value;
in the case where the trust metric is greater than or equal to a first threshold value and less than a second threshold value, allowing the predetermined unit to access the power Internet of Things at any time point;
in a case where the trust metric is less than the first threshold and greater than or equal to a third threshold, allowing the predetermined unit to access the power Internet of Things at a pre-set number of time points;
in a case where the trust metric is less than the third threshold value and greater than a fourth threshold value, prohibiting the predetermined unit from accessing the power Internet of Things.

8. An apparatus for controlling access to power Internet of Things, comprising:
a first calculation component, configured to calculate, according to power/power amount trading response quantity data of a predetermined unit, a two-dimensional trapezoidal fuzzy set of acquisition errors of the power/power amount trading response quantity data of the predetermined unit in a predetermined time period by a statistical analysis method, calculate, according to offer data of the predetermined unit, a two-dimensional trapezoidal fuzzy set of acquisition errors of the offer data of the predetermined unit in the predetermined time period by the statistical analysis method, calculate, according to transaction price data of an energy market, a two-dimensional trapezoidal fuzzy set of acquisition errors of the transaction price data of the energy market in the predetermined time period by the statistical analysis method, calculate, according to power/power amount demand quantity data of a power market, a two-dimensional trapezoidal fuzzy set of acquisition errors of the power/power amount demand quantity data of the power market in the predetermined time period by the statistical analysis method, calculate, according to energy trading security check time data, a plurality of two-dimensional trapezoidal fuzzy sets of a plurality of fuzzy uncertainties at different levels of the energy trading security check time data in the predetermined time period by the statistical analysis method, wherein the predetermined unit comprises a hydro-power unit, a thermal power unit, a nuclear power unit and an air power unit;
a second calculation component, configured to calculate, according to data transmission rate data of an Internet of Things monitoring data center, a plurality of two-dimensional trapezoidal fuzzy sets of a plurality of fuzzy uncertainties at different levels of the data transmission rate data by the statistical analysis method, calculate, according to data storage sharing scale data of the Internet of Things monitoring data center, a plurality of two-dimensional trapezoidal fuzzy sets of a plurality of fuzzy uncertainties at different levels of the data storage sharing scale data by the statistical analysis method;
a third calculation component, configured to calculate a first target acquisition error in the predetermined time period according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, and calculate a second target acquisition error in the predetermined time period according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, wherein the first target acquisition error is an acquisition error of the power/power amount trading response quantity data of the predetermined unit participating in market competition formed in the power Internet of Things, the second target acquisition error is an acquisition error of the offer data of the predetermined unit participating in the market competition formed in the power Internet of Things;
a fourth calculation component, configured to calculate a target information benefit value according to the plurality of two-dimensional trapezoidal fuzzy sets of the plurality of fuzzy uncertainties at different levels of the data transmission rate data, the plurality of two-dimensional trapezoidal fuzzy sets of the plurality of fuzzy uncertainties at different levels of the data storage sharing scale data and an information benefit value formed by the power Internet of Things providing a data acquisition to the predetermined unit in a sensing layer, wherein the target information benefit value is an information benefit value obtained by the power Internet of Things providing data acquisition, data transmission, data storage and data sharing to the predetermined unit in a market transaction;
a fifth calculation component, configured to calculate a first target information loss value according to the plurality of two-dimensional trapezoidal fuzzy sets of the plurality of fuzzy uncertainties at different levels of the energy trading security check time data in the predetermined time period, the first target acquisition error in the predetermined time period and the second target acquisition error in the predetermined time period; and calculate a second target information loss value according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period; and calculate a third target information loss value according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, wherein the first target information loss value is an information loss value of a market transaction caused by the acquisition errors of the power/power amount transaction response data of the predetermined unit participating in the market competition formed in the power Internet of Things, the acquisition errors of the offer data of the predetermined unit participating in the market competition formed in the power Internet of Things, and the energy trading security check time data in the predetermined time period, the second target information loss value is an information loss value of the market transaction caused by the acquisition errors of the power/power amount trading response quantity data of the predetermined unit participating in the market competition formed in the power Internet of Things in the market transaction, the third target information loss value is an information loss value of the market transaction caused by the acquisition errors of the offer data of the predetermined unit participating in the market competition formed in the power Internet of Things in the market transaction;
a sixth calculation component, configured to calculate a trust metric of the power Internet of Things to the predetermined unit according to the target information benefit value, the first target information loss value, the second target information loss value and the third target information loss value, and perform access control of the predetermined unit according to the trust metric.

9. A non-transitory computer readable storage medium, wherein the non-transitory computer readable storage medium comprises a program stored, and when running, the program controls a device where the non-transitory computer readable storage medium is located to:
calculate, according to power/power amount trading response quantity data of a predetermined unit, a two-dimensional trapezoidal fuzzy set of acquisition errors of the power/power amount trading response quantity data of the predetermined unit in a predetermined time period by a statistical analysis method, calculate, according to offer data of the predetermined unit, a two-dimensional trapezoidal fuzzy set of acquisition errors of the offer data of the predetermined unit in the predetermined time period by the statistical analysis method, calculate, according to transaction price data of an energy market, a two-dimensional trapezoidal fuzzy set of acquisition errors of the transaction price data of the energy market in the predetermined time period by the statistical analysis method, calculate, according to power/power amount demand quantity data of a power market, a two-dimensional trapezoidal fuzzy set of acquisition errors of the power/power amount demand quantity data of the power market in the predetermined time period by the statistical analysis method, calculate, according to energy trading security check time data, a plurality of two-dimensional trapezoidal fuzzy sets of a plurality of fuzzy uncertainties at different levels of the energy trading security check time data in the predetermined time period by the statistical analysis method, wherein the predetermined unit comprises a hydro-power unit, a thermal power unit, a nuclear power unit and an air power unit;
calculate, according to data transmission rate data of an Internet of Things monitoring data center, a plurality of two-dimensional trapezoidal fuzzy sets of a plurality of fuzzy uncertainties at different levels of the data transmission rate data by the statistical analysis method, calculate, according to data storage sharing scale data of the Internet of Things monitoring data center, a plurality of two-dimensional trapezoidal fuzzy sets of a plurality of fuzzy uncertainties at different levels of the data storage sharing scale data by the statistical analysis method;
calculate a first target acquisition error in the predetermined time period according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, and calculate a second target acquisition error in the predetermined time period according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, wherein the first target acquisition error is an acquisition error of the power/power amount trading response quantity data of the predetermined unit participating in market competition formed in the power Internet of Things, the second target acquisition error is an acquisition error of the offer data of the predetermined unit participating in the market competition formed in the power Internet of Things;
calculate a target information benefit value according to the plurality of two-dimensional trapezoidal fuzzy sets of the plurality of fuzzy uncertainties at different levels of the data transmission rate data, the plurality of two-dimensional trapezoidal fuzzy sets of the plurality of fuzzy uncertainties at different levels of the data storage sharing scale data and an information benefit value formed by the power Internet of Things providing a data acquisition to the predetermined unit in a sensing layer, wherein the target information benefit value is an information benefit value obtained by the power Internet of Things providing data acquisition, data transmission, data storage and data sharing to the predetermined unit in a market transaction;
calculate a first target information loss value according to the plurality of two-dimensional trapezoidal fuzzy sets of the plurality of fuzzy uncertainties at different levels of the energy trading security check time data in the predetermined time period, the first target acquisition error in the predetermined time period and the second target acquisition error in the predetermined time period; and calculate a second target information loss value according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period; and calculate a third target information loss value according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, wherein the first target information loss value is an information loss value of a market transaction caused by the acquisition errors of the power/power amount transaction response data of the predetermined unit participating in the market competition formed in the power Internet of Things, the acquisition errors of the offer data of the predetermined unit participating in the market competition formed in the power Internet of Things, and the energy trading security check time data in the predetermined time period, the second target information loss value is an information loss value of the market transaction caused by the acquisition errors of the power/power amount trading response quantity data of the predetermined unit participating in the market competition formed in the power Internet of Things in the market transaction, the third target information loss value is an information loss value of the market transaction caused by the acquisition errors of the offer data of the predetermined unit participating in the market competition formed in the power Internet of Things in the market transaction;
calculate a trust metric of the power Internet of Things to the predetermined unit according to the target information benefit value, the first target information loss value, the second target information loss value and the third target information loss value, and perform access control of the predetermined unit according to the trust metric.

10. A processor, wherein the processor is configured to run a program, and when running, the program executes the method for controlling access to the power Internet of Things according to claim 1.

11. The non-transitory computer readable storage medium as claimed in claim 9, wherein the two-dimensional trapezoidal fuzzy set of the acquisition errors of the power/power amount trading response quantity data of the predetermined unit in the predetermined time period is:
$$\text{?} = ( \text{?} ) = [ ( \text{?} ; \text{?} ) , ( \text{?} ; \text{?} ) ] ;$$
$$\text{?} = ( \text{?} ) = [ ( \text{?} ; \text{?} ) , ( \text{?} ; \text{?} ) ] ;$$
$$\text{?} = ( \text{?} ) = [ ( \text{?} ; \text{?} ) , ( \text{?} ; \text{?} ) ] ;$$
$$\text{?} = ( \text{?} ) = [ ( \text{?} ; \text{?} ) , ( \text{?} ; \text{?} ) ] ;$$
$$\text{?} \text{indicates text missing or illegible when filed}$$
wherein t is the predetermined time period, e_{RPH}^{t} is the two-dimensional trapezoidal fuzzy set of the acquisition errors of the power/power amount trading response quantity data of the hydro-power unit in the predetermined time period, e_{RPHLj}^{t} is a fuzzy number corresponding to a lower bound of a two-dimensional trapezoidal fuzzy set of acquisition errors of the power/power amount trading response quantity data of the hydro-power unit in the predetermined period, k_{eRPHL}^{t} is a membership coefficient of a fuzzy number corresponding to the lower bound of the two-dimensional trapezoidal fuzzy set of the acquisition errors of the power/power amount trading response quantity data of the hydro-power unit in the predetermined period, e_{RPHUj}^{t} is a fuzzy number corresponding to an upper bound of the two-dimensional trapezoidal fuzzy set of the acquisition errors of the power/power amount trading response quantity data of the hydro-power unit in the predetermined period, k_{eRPHU}^{t} is a membership coefficient of the fuzzy number corresponding to the upper bound of the two-dimensional trapezoidal fuzzy set of the acquisition errors of the power/power amount trading response quantity data of the hydro-power unit in the predetermined period, e_{RPT}^{t} is the two-dimensional trapezoidal fuzzy set of the acquisition errors of the power/power amount trading response quantity data of the thermal power unit in the predetermined time period, e_{RTILj}^{t} is a fuzzy number corresponding to a lower bound of the two-dimensional trapezoidal fuzzy set of the acquisition errors of the power/power amount trading response quantity data of the thermal power unit in the predetermined time period, k_{eRPTL}^{t} is a membership coefficient of the fuzzy number corresponding to the lower bound of the two-dimensional trapezoidal fuzzy set of the acquisition errors of the power/power amount trading response quantity data of the thermal power unit in the predetermined period, e_{RPTUj}^{t} is a fuzzy number corresponding to an upper bound of the two-dimensional trapezoidal fuzzy set of the acquisition errors of the power/power amount trading response quantity data of the thermal power unit in the predetermined time period, k_{eRPTU}^{t} is a membership coefficient of the fuzzy number corresponding to the upper bound of the two-dimensional trapezoidal fuzzy set of the acquisition errors of the power/power amount trading response quantity data of the thermal power unit in the predetermined period, e_{RPN}^{t} is the two-dimensional trapezoidal fuzzy set of the acquisition errors of the power/power amount trading response quantity data of the nuclear power unit in the predetermined time period, e_{RPNLj}^{t} is a fuzzy number corresponding to a lower bound of the two-dimensional trapezoidal fuzzy set of the acquisition errors of the power/power amount trading response quantity data of the nuclear power unit in the predetermined period, RN is a membership coefficient of the fuzzy number corresponding to the lower bound of the two-dimensional trapezoidal ambiguous set of acquisition errors of the power/power amount trading response quantity data of the nuclear power unit in the predetermined time period, e_{RPNUj}^{t} is a fuzzy number corresponding to an upper bound of the two-dimensional trapezoidal fuzzy set of the acquisition errors of the power/power amount trading response quantity data of the nuclear power unit in the predetermined period, k_{eRPNU}^{t} is a membership coefficient of the fuzzy number corresponding to the upper bound of the two-dimensional trapezoidal fuzzy set of the acquisition errors of the power/power amount trading response quantity data of the nuclear power unit in the predetermined time period, e_{RPG}^{t} is the two-dimensional trapezoidal fuzzy set of the acquisition errors of the power/power amount trading response quantity data of the air power unit in the predetermined time period, e_{RPGLj}^{t} is a fuzzy number corresponding to a lower bound of the two-dimensional trapezoidal fuzzy set of the acquisition errors of the power/power amount trading response quantity data of the air power unit in the predetermined time period, k_{eRPGL}^{t} is a membership coefficient of the fuzzy number corresponding to the lower bound of the two-dimensional trapezoidal fuzzy set of the acquisition errors of the power/power amount trading response quantity data of the air power unit in the predetermined time period, e_{RPGUj}^{t} is a fuzzy number corresponding to an upper bound of the two-dimensional trapezoidal fuzzy set of the acquisition errors of the power/power amount trading response quantity data of the air power unit in the predetermined time period, k_{eRPGU}^{t} is a membership coefficient of the fuzzy number corresponding to the upper bound of the two-dimensional trapezoidal fuzzy set of the acquisition errors of the power/power amount trading response quantity data of the air power unit in the predetermined time period, t=1, 2, . . . , N_{RP}, j=1, 2, 3, 4;
the two-dimensional trapezoidal fuzzy set of the acquisition errors of the offer data of the predetermined unit in the predetermined time period is:
$$\text{?} = ( \text{?} ) = [ ( \text{?} ; \text{?} ) , ( \text{?} ; \text{?} ) ] ;$$
$$\text{?} = ( \text{?} ) = [ ( \text{?} ; \text{?} ) , ( \text{?} ; \text{?} ) ] ;$$
$$\text{?} = ( \text{?} ) = [ ( \text{?} ; \text{?} ) , ( \text{?} ; \text{?} ) ] ;$$
$$\text{?} = ( \text{?} ) = [ ( \text{?} ; \text{?} ) , ( \text{?} ; \text{?} ) ] ;$$
$$\text{?} \text{indicates text missing or illegible when filed}$$
wherein e_{RpH}^{t} is the two-dimensional trapezoidal fuzzy set of the acquisition errors of the offer data of the hydro-power unit in the predetermined time period, e_{RpHLj}^{t} is a fuzzy number corresponding to a lower bound of the two-dimensional trapezoidal fuzzy set of the acquisition errors of the offer data of the hydro-power unit in the predetermined period, k_{eRpHL}^{t} is a membership coefficient of the fuzzy number corresponding to the lower bound of the two-dimensional trapezoidal fuzzy set of the acquisition errors of the offer data of the hydro-power unit in the predetermined time period, e_{RpHUj}^{t} is a fuzzy number corresponding to an upper bound of the two-dimensional trapezoidal fuzzy set of the acquisition errors of the offer data of the hydro-power unit in the predetermined period, k_{eRpHU}^{t} is a membership coefficient of the fuzzy number corresponding to the upper bound of the two-dimensional trapezoidal fuzzy set of the acquisition errors of the offer data of the hydro-power unit in the predetermined period, e_{RpT}^{t} is the two-dimensional trapezoidal fuzzy set of the acquisition errors of the offer data of the thermal power unit in the predetermined time period, e_{RpTLj}^{t} is a fuzzy number corresponding to a lower bound of the two-dimensional trapezoidal fuzzy set of the acquisition errors of the offer data of the thermal power unit in the predetermined time period, k_{cRpTL}^{t} is a membership coefficient of the fuzzy number corresponding to the lower bound of the two-dimensional trapezoidal fuzzy set of the acquisition errors of the offer data of the thermal power unit in the predetermined time period, e_{RpTUj}^{t} is a fuzzy number corresponding to an upper bound of the two-dimensional trapezoidal fuzzy set of the acquisition errors of the offer data of the thermal power unit in the predetermined time period, k_{eRpTU}^{t} is a membership coefficient of the fuzzy number corresponding to the upper bound of the two-dimensional trapezoidal fuzzy set of the acquisition errors of the offer data of the thermal power unit in the predetermined time period, e_{RpN}^{t} is the two-dimensional trapezoidal fuzzy set of the acquisition errors of the offer data of the nuclear power unit in the predetermined time period, e_{RpNLj}^{t} is a fuzzy number corresponding to a lower bound of the two-dimensional trapezoidal fuzzy set of the acquisition errors of the offer data of the nuclear power unit in the predetermined time period, k_{eRpNL}^{t} is a membership coefficient of the fuzzy number corresponding to the lower bound of the two-dimensional trapezoidal fuzzy set of the acquisition errors of the offer data of the nuclear power unit in the predetermined time period, e_{RpNUj}^{t} is a fuzzy number corresponding to an upper bound of the two-dimensional trapezoidal fuzzy set of the acquisition errors of the offer data of the nuclear power unit in the predetermined time period, k_{eRPU}^{t} is a membership coefficient of the fuzzy number corresponding to the upper bound of the two-dimensional trapezoidal fuzzy set of the acquisition errors of the offer data of the nuclear power unit in the predetermined period, e_{RpG}^{t} is the two-dimensional trapezoidal fuzzy set of the acquisition errors of the offer data of the air power unit in the predetermined time period, e_{RpGLj}^{t} is a fuzzy number corresponding to a lower bound of the two-dimensional trapezoidal fuzzy set of the acquisition errors of the offer data of the air power unit in the predetermined time period, k_{eRpGL}^{t} is a membership coefficient of the fuzzy number corresponding to the lower bound of the two-dimensional trapezoidal fuzzy set of the acquisition error of the offer data of the air power unit in the predetermined time period, e_{RpGUj}^{t} is a fuzzy number corresponding to an upper bound of the two-dimensional trapezoidal fuzzy set of the acquisition errors of the offer data of the air power unit in the predetermined time period, k_{eRpGU}^{t} is a membership coefficient of the fuzzy number corresponding to the upper bound of the two-dimensional trapezoidal fuzzy set of the acquisition errors of the offer data of the air power unit in the predetermined time period;
the two-dimensional trapezoidal fuzzy set of the acquisition errors of the transaction price data of the energy market in the predetermined time period is:
$${e}_{Rp}^{\text{?}} = ( {e}_{RpL}^{\text{?}} , {e}_{RpU}^{\text{?}} ) = [ ( {e}_{RpL 1}^{\text{?}} , {e}_{RpL 2}^{\text{?}} , {e}_{RpL 3}^{\text{?}} , {e}_{RpL 4}^{\text{?}} ; {k}_{eRpL}^{\text{?}} ) , ( {e}_{RpU 1}^{\text{?}} , {e}_{RpU 2}^{\text{?}} , {e}_{RpU 3}^{\text{?}} , {e}_{RpU 4}^{\text{?}} ; {k}_{eRpU}^{\text{?}} ) ] ;$$
$$\text{?} \text{indicates text missing or illegible when filed}$$
wherein e_{Rp}^{t} is the two-dimensional trapezoidal fuzzy set of the acquisition errors of the transaction price data of the energy market in the predetermined time period, e_{RpLj}^{t} is a fuzzy number corresponding to a lower bound of the two-dimensional trapezoidal fuzzy set of the acquisition errors of the transaction price data of the energy market in the predetermined time period, k_{eRpL}^{t} is a membership coefficient of the fuzzy number corresponding to the lower bound of the two-dimensional trapezoidal fuzzy set of the acquisition errors of the transaction price data of the energy market in the predetermined time period, e_{RPUj}^{t} is a fuzzy number corresponding to an upper bound of the two-dimensional trapezoidal fuzzy set of the acquisition errors of the transaction price data of the energy market in the predetermined time period, k_{eRpU}^{t} is a membership coefficient of the fuzzy number corresponding to the upper bound of the two-dimensional trapezoidal fuzzy set of the acquisition errors of the transaction price data of the energy market in the predetermined time period;
the two-dimensional trapezoidal fuzzy set of the acquisition errors of the power/power amount demand quantity data of the power market in the predetermined time period is:
$${e}_{Rp}^{\text{?}} = ( {e}_{RpL}^{\text{?}} , {e}_{RpU}^{\text{?}} ) = [ ( {e}_{RpL 1}^{\text{?}} , {e}_{RpL 2}^{\text{?}} , {e}_{RpL 3}^{\text{?}} , {e}_{RpL 4}^{\text{?}} ; {k}_{eRpL}^{\text{?}} ) , ( {e}_{RpU 1}^{\text{?}} , {e}_{RpU 2}^{\text{?}} , {e}_{RpU 3}^{\text{?}} , {e}_{RpU 4}^{\text{?}} ; {k}_{eRpU}^{\text{?}} ) ] ;$$
$$\text{?} \text{indicates text missing or illegible when filed}$$
wherein e_{RP}^{t} is the two-dimensional trapezoidal fuzzy set of the acquisition errors of the power/power amount demand quantity data of the power market in the predetermined period, e_{RPLj}^{t} is a fuzzy number corresponding to a lower bound of the two-dimensional trapezoidal fuzzy set of the acquisition errors of the power/power amount demand quantity data of the power market in the predetermined period, k_{CRPL}^{t} is a membership coefficient of the fuzzy number corresponding to the lower bound of the two-dimensional trapezoidal fuzzy set of the acquisition errors of the power/power amount demand quantity data of the power market in the predetermined time period, e_{RPUj}^{t} is a fuzzy number corresponding to an upper bound of the two-dimensional trapezoidal fuzzy set of the acquisition errors of the power/power amount demand quantity data of the power market in the predetermined period, k_{eRPU}^{t} is a membership coefficient of the fuzzy number corresponding to the upper bound of the two-dimensional trapezoidal fuzzy set of the acquisition errors of the power/power amount demand quantity data of the power market in the predetermined time period;
the plurality of two-dimensional trapezoidal fuzzy sets of the plurality of fuzzy uncertainties at different levels of the energy trading security check time data in the predetermined time period is:
$${T}_{Si} = ( {T}_{SiL} , {T}_{SiU} ) = [ ( {T}_{SiL 1} , {T}_{SiL 2} , {T}_{SiL 3} , {T}_{SiL 4} ; {k}_{rSiL} ) , ( {T}_{SiU 1} , {T}_{SiU 2} , {T}_{SiU 3} , {T}_{SiU 4} ; {k}_{rSiU} ) ] ;$$
wherein, T_{Si} is a ith two-dimensional trapezoidal fuzzy set of the energy trading security check time data, and T_{SiL} is a fuzzy number corresponding to a lower bound of the two-dimensional trapezoidal fuzzy set of a ith fuzzy uncertainty of the energy trading security check time data, k_{TSiL} is a membership coefficient of the fuzzy number corresponding to the lower bound of the two-dimensional trapezoidal fuzzy set of the ith fuzzy uncertainty of the energy trading security check time data, T_{SiU} is a fuzzy number corresponding to an upper bound of the two-dimensional trapezoidal fuzzy set of the ith fuzzy uncertainty of the energy trading security check time data, k_{TSiU} is a membership coefficient of the fuzzy number corresponding to the upper bound of the two-dimensional trapezoidal fuzzy set of the ith fuzzy uncertainty of the energy trading security check time data.

12. The non-transitory computer readable storage medium as claimed in claim 9, wherein when running, the program controls the device further to:
according to the data transmission rate data of the Internet of Things monitoring data center, the plurality of two-dimensional trapezoidal fuzzy sets of nine fuzzy uncertainties of extremely low, very low, low, slightly low, medium, slightly high, high, very high and extremely high of the data transmission rate data are respectively calculated by the statistical analysis method:
$$\begin{matrix}{v}_{Di} = ( {v}_{DiL} , {v}_{DiU} ) = [ ( {v}_{DiL 1} , {v}_{DiL 2} , {v}_{DiL 3} , {v}_{DiL 4} ; {k}_{DiL} ) , ( {v}_{DiL 1} , {v}_{DiL 2} , {v}_{DiL 3} , {v}_{DiL 4} ; {k}_{DiL} ) \\ i = 1 , 2 , … , 9 ;\end{matrix}$$
wherein, v_{Di} is a ith two-dimensional trapezoidal fuzzy set of the data transmission rate data, v_{DiL} is a fuzzy number corresponding to a lower bound of the two-dimensional trapezoidal fuzzy set of a ith fuzzy uncertainty of the data transmission rate data; k_{DvL} is a membership coefficient of the fuzzy number corresponding to the lower bound of the two-dimensional trapezoidal fuzzy set of the ith fuzzy uncertainty of the data transmission rate data, v_{DiU} is a fuzzy number corresponding to an upper bound of the two-dimensional trapezoidal fuzzy set of the ith fuzzy uncertainty of the data transmission rate data, and k_{DviU} is a membership coefficient of the fuzzy number corresponding to the upper bound of the two-dimensional trapezoidal fuzzy set of the ith fuzzy uncertainty of the data transmission rate data;
according to the data storage sharing scale data of the Internet of Things monitoring data center, the plurality of two-dimensional trapezoidal fuzzy sets of nine fuzzy uncertainties of extremely low, very low, low, slightly low, medium, slightly high, high, very high and extremely high of the data storage sharing scale data are respectively calculated by the statistical analysis method:
$${S}_{Di} = ( {S}_{DiL} , {S}_{DiU} ) = [ ( {S}_{DiL 1} , {S}_{DiL 2} , {S}_{DiL 3} , {S}_{DiL 4} ; {k}_{DSiL} ) , ( {S}_{DiU 1} , {S}_{DiU 2} , {S}_{DiU 3} , {S}_{DiU 4} ; {k}_{DSiU} ) ] ;$$
wherein, S_{Di} is a ith two-dimensional trapezoidal fuzzy set of the data storage sharing scale data, S_{DiL} is a fuzzy number corresponding to a lower bound of the two-dimensional trapezoidal fuzzy set of a ith fuzzy uncertainty of the data storage sharing scale data, k_{DSiL} is a membership coefficient of the fuzzy number corresponding to the lower bound of the two-dimensional trapezoidal fuzzy set of the ith fuzzy uncertainty of the data storage sharing scale data, S_{DiU} is a fuzzy number corresponding to an upper bound of the two-dimensional trapezoidal fuzzy set of the ith fuzzy uncertainty of the data storage sharing scale data, and k_{DSiU}, is a membership coefficient of the fuzzy number corresponding to the upper bound of the two-dimensional trapezoidal fuzzy set of the ith fuzzy uncertainty of the data storage sharing scale data.

13. The non-transitory computer readable storage medium as claimed in claim 11, wherein when running, the program controls the device further to:
according to the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period, the first target acquisition error in the predetermined time period is calculated:
$${e}_{P}^{\text{?}} = E [ {e}_{RP}^{\text{?}} ⊗ ( {e}_{RPH}^{\text{?}} + {e}_{RPT}^{\text{?}} + {e}_{RPN}^{\text{?}} + {e}_{RPG}^{\text{?}} ) ] ;$$
$$\text{?} \text{indicates text missing or illegible when filed}$$
wherein, E[ ] represents a expected value to be taken in [ ], and ⊗ represents a union of fuzzy sets;
according to the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period, the second target acquisition error in the predetermined time period is calculated:
$${e}_{P}^{\text{?}} = E [ {e}_{Rp}^{\text{?}} ⊗ ( {e}_{RpH}^{\text{?}} + {e}_{RpT}^{\text{?}} + {e}_{RpN}^{\text{?}} + {e}_{RpG}^{\text{?}} ) ] .$$
$$\text{?} \text{indicates text missing or illegible when filed}$$

14. The non-transitory computer readable storage medium as claimed in claim 12, wherein when running, the program controls the device further to:
the plurality of two-dimensional trapezoidal fuzzy sets of the plurality of fuzzy uncertainties at different levels of the data transmission rate data, the plurality of two-dimensional trapezoidal fuzzy sets of the plurality of fuzzy uncertainties at different levels of the data storage sharing scale data, and the information benefit value formed by the power Internet of Things providing the data acquisition to the predetermined unit in the sensing layer are substituted into a target information benefit value calculation formula, and the target information benefit value is calculated;
wherein the target information benefit value calculation formula is:
$${R}_{RP} = E [ {{⋁}^{9}}_{i = 1} {k}_{Di} {v}_{Dvi} ⊗ {{⋁}^{9}}_{i = 1} {k}_{DSi} {S}_{D i} ⊗ {k}_{Mi} ( {M}_{\text{?}} + {M}_{T} + {M}_{N} + {M}_{G} ) ] ;$$
$$\text{?} \text{indicates text missing or illegible when filed}$$
R_{RP} is the target information benefit value,
$${{⋁}^{9}}_{i = 1} {k}_{Di} {v}_{Dvi}$$
is an information benefit value formed when the power Internet of Things provides the data transmission rate data at nine fuzzy uncertainties rates of extremely low, very low, low, slightly low, medium, slightly high, high, very high and extremely high to the predetermined unit, k_{Dvi} is a unit benefit value brought to the predetermined unit due to the power Internet of Things providing the data transmission rate data at a ith rate,
$${{⋁}^{9}}_{i = 1} {k}_{DSi} {S}_{D i}$$
is an information benefit value formed when the power Internet of Things providing the data storage sharing scale data of nine fuzzy uncertainties scales of extremely low, very low, low, slightly low, medium, slightly high, high, very high and extremely high to the predetermined unit, k_{DSi} is a unit benefit value brought to the predetermined unit due to the power Internet of Things providing the data storage sharing scale data at the ith rate, k_{Mi}M_{H} is an information benefit value formed when the power Internet of Things provides the data acquisition to the hydro-power unit in the sensing layer k_{Mi}M_{T} is an information benefit value formed when the power Internet of Things providing the data acquisition to the thermal power unit in the sensing layer, k_{Mi}Mₙ is an information benefit value formed when the power acquisition layer provides the data acquisition to the nuclear power unit in the sensing layer, k_{Mi}M_{G} is an information benefit value when the power acquisition layer provides the data acquisition to the air power unit in the sensing layer, and k_{Mi} is a unit benefit value brought to the predetermined unit due to the power Internet of Things providing the data acquisition for the predetermined unit in the sensing layer. E[ ] is a expected value to be taken in [ ],
$${{⋁}^{9}}_{\dot{a} = 1}$$
represents a union of nine fuzzy sets.

15. The non-transitory computer readable storage medium as claimed in claim 13, wherein when running, the program controls the device further to:
the plurality of two-dimensional trapezoidal fuzzy sets of the plurality of fuzzy uncertainties at different levels of the energy trading security check time data in the predetermined time period, the first target acquisition error in the predetermined time period and the second target acquisition error in the predetermined time period are substituted into a first target information loss value calculation formula, and the first target information loss value is calculated, wherein the first target information loss value calculation formula is:
$${L}_{R} = {\sum }_{\text{?} = 1}^{N \text{?}} ( {k}_{PW}^{t} {k}_{PI}^{t} {e}_{P}^{t} + {k}_{p W}^{t} {k}_{pI}^{t} {e}_{p}^{t} + {k}_{TW}^{t} {k}_{TI}^{t} E [ {{⋁}^{9}}_{i = 1} {T}_{Si}^{t} ] ) ;$$
$$\text{?} \text{indicates text missing or illegible when filed}$$
L_{R} is the first target information loss value, k_{PW}^{t} is an influence coefficient or weight coefficient of the first target acquisition error, k_{Pl}^{t} is a unit loss value brought about by the first target acquisition error, k_{Pw}^{t} is an influence coefficient or weight coefficient of the second target acquisition error, kₚₗ^{t} is a unit loss value brought about by the second target acquisition error, k_{TW}^{t} is an influence coefficient or weight coefficient of the energy trading security check time data, and k_{Tl}^{t} is a unit loss value brought about by the energy trading security check time data;
the two-dimensional trapezoidal fuzzy set of the acquisition errors of the power/power amount trading response quantity data of the predetermined unit in the predetermined time period and the two-dimensional trapezoidal fuzzy set of the acquisition errors of the power/power amount demand quantity data of the power market in the predetermined time period are substituted into a second target information loss value calculation formula, and the second target information loss value is calculated, wherein the second target information loss value calculation formula is:
$$\begin{matrix}{L}_{RP} = {L}_{RPH} + {L}_{RPT} + {L}_{RPN} + {L}_{RPG} ; \\ {L}_{RPH} = {\sum }_{t = 1}^{N \text{?}} {k}_{PW}^{\text{?}} {k}_{PI}^{\text{?}} E [ {e}_{RP}^{\text{?}} ] \cdot E [ {e}_{RPH}^{\text{?}} ] ; \\ {L}_{RPT} = {\sum }_{t = 1}^{N \text{?}} {k}_{PW}^{\text{?}} {k}_{PI}^{\text{?}} E [ {e}_{RP}^{\text{?}} ] \cdot E [ {e}_{RPG}^{\text{?}} ] ; \\ {L}_{RPN} = {\sum }_{t = 1}^{N \text{?}} {k}_{PW}^{\text{?}} {k}_{PI}^{\text{?}} E [ {e}_{RP}^{\text{?}} ] \cdot E [ {e}_{RPN}^{\text{?}} ] ; \\ {L}_{RPG} = {\sum }_{t = 1}^{N \text{?}} {k}_{PW}^{\text{?}} {k}_{PI}^{\text{?}} E [ {e}_{RP}^{\text{?}} ] \cdot E [ {e}_{RPG}^{\text{?}} ] ;\end{matrix}$$
$$\text{?} \text{indicates text missing or illegible when filed}$$
the two-dimensional trapezoidal fuzzy set of the acquisition errors of the offer data of the predetermined unit in the predetermined time period and the two-dimensional trapezoidal fuzzy set of the acquisition errors of the transaction price data of the energy market in the predetermined time period are substituted into a third target information loss value calculation formula, and the third target information loss value is calculated, wherein the third target information loss value calculation formula is:
$$\begin{matrix}{L}_{Rp} = {L}_{RpH} + {L}_{RpT} + {L}_{RpN} + {L}_{RpG} ; \\ {L}_{RpH} = {\sum }_{t = 1}^{N \text{?}} {k}_{p W}^{\text{?}} {k}_{pI}^{\text{?}} E [ {e}_{Rp}^{\text{?}} ] \cdot E [ {e}_{RpH}^{\text{?}} ] ; \\ {L}_{RpT} = {\sum }_{t = 1}^{N \text{?}} {k}_{p W}^{\text{?}} {k}_{pI}^{\text{?}} E [ {e}_{Rp}^{\text{?}} ] \cdot E [ {e}_{RpG}^{\text{?}} ] ; \\ {L}_{RpN} = {\sum }_{t = 1}^{N \text{?}} {k}_{p W}^{\text{?}} {k}_{pI}^{\text{?}} E [ {e}_{Rp}^{\text{?}} ] \cdot E [ {e}_{RpN}^{\text{?}} ] ; \\ {L}_{RpG} = {\sum }_{t = 1}^{N \text{?}} {k}_{p W}^{\text{?}} {k}_{pI}^{\text{?}} E [ {e}_{Rp}^{\text{?}} ] \cdot E [ {e}_{RpG}^{\text{?}} ] ;\end{matrix}$$
$$\text{?} \text{indicates text missing or illegible when filed}$$

16. The non-transitory computer readable storage medium as claimed in claim 9, wherein when running, the program controls the device further to:
the target information benefit value, the first target information loss value, the second target information loss value and the third target information loss value are substituted into a trust metric calculation formula, and the trust metric is calculated;
wherein, the trust metric calculation formula is:
$${B}_{\text{?}} = \frac{{R}_{RP}}{{R}_{RP} + \frac{{L}_{R} + {L}_{RP} + {L}_{Rp}}{2}} ;$$
$$\text{?} \text{indicates text missing or illegible when filed}$$
B_{I} is the trust metric, R_{RP} is the target information benefit value, L_{R} is the first target information loss value, L_{RP} is the second target information loss value, and L_{RP} is the third target information loss value;
in the case where the trust metric is greater than or equal to a first threshold value and less than a second threshold value, the predetermined unit is allowed to access the power Internet of Things at any time point;
in a case where the trust metric is less than the first threshold and greater than or equal to a third threshold, the predetermined unit is allowed to access the power Internet of Things at a pre-set number of time points;
in a case where the trust metric is less than the third threshold value and greater than a fourth threshold value, the predetermined unit is prohibited from accessing the power Internet of Things.
